(19) United States
(12) Patent Application Publication
(10) Pub. No.: US 2025/0284102 A1
(43) Pub. Date: Sep. 11, 2025

(54) LIGHT PATH FOLDING MODULE, CAMERA MODULE AND ELECTRONIC DEVICE

(71) Applicant: LARGAN PRECISION CO., LTD., Taichung City (TW)

(72) Inventors: Heng-Yi SU, Taichung City (TW); Chun-Tang TSAI, Taichung City (TW); Ming-Ta CHOU, Taichung City (TW); Ming-Shun CHANG, Taichung City (TW)

(21) Appl. No.: 19/021,489

(22) Filed: Jan. 15, 2025

(30) Foreign Application Priority Data
Mar. 8, 2024 (TW) 113108658

(51) Int. Cl. G02B 13/00; G03B 30/00

(52) U.S. Cl. CPC G02B 13/0065; G03B 30/00

(57) ABSTRACT

A light path folding module includes a light path folding element and an opaque body. The light path folding element is for folding an incident optical axis to an exiting optical axis, and the light path folding element includes a light incident surface and a light exiting surface. The opaque body is disposed relative to the light path folding element, and the opaque body includes a non-closed ring structure and a plurality of light blocking structures. The exiting optical axis passes through a notch opening of the non-closed ring structure. The light blocking structures extend toward the exiting optical axis from the non-closed ring structure along a direction perpendicular to the exiting optical axis, wherein the light blocking structures are disposed adjacent to the light exiting surface of the light path folding element.

### RELATED APPLICATIONS

This application claims priority to Taiwan Application Serial Number 113108658, filed Mar. 8, 2024, which is herein incorporated by reference.

### BACKGROUND

### Technical Field

The present disclosure relates to a light path folding module and a camera module. More particularly, the present disclosure relates to a light path folding module and a camera module which are applicable to portable electronic device.

### Description of Related Art

In recent years, portable electronic devices have developed rapidly. For example, intelligent electronic devices and tablets have been filled in the lives of modern people, and camera modules mounted on portable electronic devices have also prospered. However, as the technology advances, the quality requirements of camera module are becoming higher and higher. Therefore, developing a camera module that can improve the imaging quality has become an important and urgent problem in the industry.

### SUMMARY

According to one aspect of the present disclosure, a light path folding module includes a light path folding element and an opaque body. The light path folding element is for folding an incident optical axis to an exiting optical axis, and the light path folding element includes a light incident surface and a light exiting surface. The incident optical axis passes through and enters into the light incident surface. The exiting optical axis passes through and is away from the light exiting surface. The opaque body is disposed relative to the light path folding element, and the opaque body includes a non-closed ring structure and a plurality of light blocking structures. The exiting optical axis passes through a notch opening of the non-closed ring structure. The plurality of light blocking structures extend towards the exiting optical axis from the non-closed ring structure along a direction perpendicular to the exiting optical axis, wherein the plurality of light blocking structures are disposed adjacent to the light exiting surface of the light path folding element. When the exiting optical axis as a center of circle is taken, an angle occupied by the plurality of light blocking structures is θe, and a number of the plurality of light blocking structures is Ne, the following conditions are satisfied: 10 degrees<θe<350 degrees; and 15<Ne<460.

According to another aspect of the present disclosure, a camera module includes the light path folding module according to the foregoing aspect and an imaging lens assembly. The imaging lens assembly is disposed adjacent to the light path folding module.

According to another aspect of the present disclosure, an electronic device includes the camera module according to the foregoing aspect and an image sensor. The image sensor is disposed on an imaging surface of the camera module.

According to another aspect of the present disclosure, a light path folding module includes a light path folding element and an opaque body. The light path folding element is for folding an incident optical axis to an exiting optical axis, and the light path folding element includes a light incident surface and a light exiting surface. The incident optical axis passes through and enters into the light incident surface. The exiting optical axis passes through and is away from the light exiting surface. The opaque body is disposed relative to the light path folding element, and the opaque body includes a non-closed ring structure and a plurality of light blocking structures. The incident optical axis passes through a notch opening of the non-closed ring structure. The plurality of light blocking structures extend towards the incident optical axis from the non-closed ring structure along a direction perpendicular to the incident optical axis, wherein the plurality of light blocking structures are disposed adjacent to the light incident surface of the light path folding element. When the incident optical axis as a center of circle is taken, an angle occupied by the plurality of light blocking structures is θi, and a number of the plurality of light blocking structures is Ni, the following conditions are satisfied: 10 degrees<θi<350 degrees; and 15<Ni<460.

### BRIEF DESCRIPTION OF THE DRAWINGS

The present disclosure can be more fully understood by reading the following detailed description of the embodiment, with reference made to the accompanying drawings as follows:

FIG. 1A is a three-dimensional schematic view of a camera module of the 1st Example according to the 1st Embodiment of the present disclosure.

FIG. 1B is an exploded view of the camera module of the 1st Example according to the 1st Embodiment in FIG. 1A.

FIG. 1C is a cross-sectional view of partial of the camera module of the 1st Example according to the 1st Embodiment in FIG. 1A.

FIG. 1D is a plane view of the camera module of the 1st Example according to the 1st Embodiment in FIG. 1A.

FIG. 1E is a cross-sectional view along line 1E-1E in FIG. 1D.

FIG. 1F is a plane view of the opaque body of the 1st Example according to the 1st Embodiment in FIG. 1A.

FIG. 1G is a plane view of the opaque body of the 2nd Example according to the 1st Embodiment in FIG. 1A.

FIG. 2A is a three-dimensional view of a camera module of the 1st Example according to the 2nd Embodiment of the present disclosure.

FIG. 2B is an exploded view of the camera module of the 1st Example according to the 2nd Embodiment in FIG. 2A.

FIG. 2C is a plane view of the camera module of the 1st Example according to the 2nd Embodiment in FIG. 2A.

FIG. 2D is a cross-sectional view along line 2D-2D in FIG. 2C.

FIG. 2E is a plane view of the opaque body of the 1st Example according to the 2nd Embodiment in FIG. 2A.

FIG. 2F is a plane view of the opaque body of the 2nd Example according to the 2nd Embodiment in FIG. 2A.

FIG. 3A is a schematic view of a light path folding module of the 1st Example according to the 3rd Embodiment of the present disclosure.

FIG. 3B is an exploded view of the light path folding module of the 1st Example according to the 3rd Embodiment in FIG. 3A.

FIG. 3C is a plane view of the light path folding module of the 1st Example according to the 3rd Embodiment in FIG. 3A.

FIG. 3D is a schematic view of the opaque body of the 1st Example according to the 3rd Embodiment in FIG. 3A.

FIG. 3E is another plane view of the light path folding module of the 1st Example according to the 3rd Embodiment in FIG. 3A.

FIG. 3F is a cross-sectional view along line 3F-3F in FIG. 3E.

FIG. 4A is a schematic view of a light path folding module of the 1st Example according to the 4th Embodiment of the present disclosure.

FIG. 4B is an exploded view of the light path folding module of the 1st Example according to the 4th Embodiment in FIG. 4A.

FIG. 4C is a plane view of the light path folding module of the 1st Example according to the 4th Embodiment in FIG. 4A.

FIG. 4D is a schematic view of the opaque body of the 1st Example according to the 4th Embodiment in FIG. 4A.

FIG. 4E is another plane view of the light path folding module of the 1st Example according to the 4th Embodiment in FIG. 4A.

FIG. 4F is a cross-sectional view along line 4F-4F in FIG. 4E.

FIG. 5A is a schematic view of a light path folding module of the 1st Example according to the 5th Embodiment of the present disclosure.

FIG. 5B is an exploded view of the light path folding module of the 1st Example according to the 5th Embodiment in FIG. 5A.

FIG. 5C is a plane view of the light path folding module of the 1st Example according to the 5th Embodiment in FIG. 5A.

FIG. 5D is a schematic view of the opaque body of the 1st Example according to the 5th Embodiment in FIG. 5A.

FIG. 5E is another plane view of the light path folding module of the 1st Example according to the 5th Embodiment in FIG. 5A.

FIG. 5F is a cross-sectional view along line 5F-5F in FIG. 5E.

FIG. 6A is a schematic view of a light path folding module of the 1st Example according to the 6th Embodiment of the present disclosure.

FIG. 6B is an exploded view of the light path folding module of the 1st Example according to the 6th Embodiment in FIG. 6A.

FIG. 6C is a plane view of the light path folding module of the 1st Example according to the 6th Embodiment in FIG. 6A.

FIG. 6D is a schematic view of the opaque body of the 1st Example according to the 6th Embodiment in FIG. 6A.

FIG. 6E is another plane view of the light path folding module of the 1st Example according to the 6th Embodiment in FIG. 6A.

FIG. 6F is a cross-sectional view along line 6F-6F in FIG. 6E.

FIG. 7A is a schematic view of a light path folding module of the 1st Example according to the 7th Embodiment of the present disclosure.

FIG. 7B is an exploded view of the light path folding module of the 1st Example according to the 7th Embodiment in FIG. 7A.

FIG. 7C is a plane view of the light path folding module of the 1st Example according to the 7th Embodiment in FIG. 7A.

FIG. 7D is a schematic view of the opaque body of the 1st Example according to the 7th Embodiment in FIG. 7A.

FIG. 7E is another plane view of the light path folding module of the 1st Example according to the 7th Embodiment in FIG. 7A.

FIG. 7F is a cross-sectional view along line 7F-7F in FIG. 7E.

FIG. 8A is a schematic view of a light path folding module of the 1st Example according to the 8th Embodiment of the present disclosure.

FIG. 8B is an exploded view of the light path folding module of the 1st Example according to the 8th Embodiment in FIG. 8A.

FIG. 8C is a plane view of the light path folding module of the 1st Example according to the 8th Embodiment in FIG. 8A.

FIG. 8D is a schematic view of the opaque body 820 of the 1st Example according to the 8th Embodiment in FIG. 8A.

FIG. 8E is another plane view of the light path folding module 800 of the 1st Example according to the 8th Embodiment in FIG. 8A.

FIG. 8F is a cross-sectional view along line 8F-8F in FIG. 8E.

FIG. 9A is a schematic view of an electronic device 90 according to the 9th Embodiment of the present disclosure.

FIG. 9B is another schematic view of the electronic device 90 according to the 9th Embodiment in FIG. 9A.

FIG. 9C is a schematic view of an image captured by the electronic device 90 according to the 9th Embodiment in FIG. 9A.

FIG. 9D is a schematic view of an image captured by the electronic device 90 according to the 9th Embodiment in FIG. 9A.

FIG. 9E is another schematic view of an image captured by the electronic device 90 according to the 9th Embodiment in FIG. 9A.

FIG. 10 is a schematic view of an electronic device according to the 10th Embodiment of the present disclosure.

FIG. 11A shows a schematic view of a vehicle device according to the 11th Embodiment of the present disclosure.

FIG. 11B shows another schematic view of the vehicle device according to the 11th Embodiment in FIG. 11A.

FIG. 11C shows further another schematic view of the vehicle device according to the 11th Embodiment in FIG. 11A.

### DETAILED DESCRIPTION

The present disclosure provides a light path folding module, which includes a light path folding element and an opaque body, wherein the opaque body is disposed relative to the light path folding element. The light path folding element is for folding an incident optical axis to an exiting optical axis, and the light path folding element includes a light incident surface and a light exiting surface. The incident optical axis passes through and enters into the light incident surface. The exiting optical axis passes through and is away from the light exiting surface. The opaque body includes a non-closed ring structure and a plurality of light blocking structures. The exiting optical axis passes through a notch opening of the non-closed ring structure. The light blocking structures extend towards the exiting optical axis from the non-closed ring structure along a direction perpendicular to the exiting optical axis, wherein the light blocking structures are disposed adjacent to the light exiting surface of the light path folding element. When the exiting optical axis as a center of circle is taken, an angle occupied by the light blocking structures is θe, and a number of the light blocking structures is Ne, the following conditions are satisfied: 10 degrees<θe<350 degrees; and 15<Ne<460. Therefore, the non-imaging light outside the field of view can be blocked by arranging the light blocking structures towards the direction of the exiting optical axis so as to maintain the image being clear.

Specifically, the light path folding element can be a prism, a reflector, etc. Each of the light blocking structures can be wedge-shaped, straight strip-shaped, petal-shaped, semi-cylindrical shape or a wavy-shaped, etc. Furthermore, if the direction parallel to the exiting optical axis is Z axis, then the direction perpendicular to the exiting optical axis is any direction on an XY plane defined by X axis and Y axis.

Furthermore, the non-closed ring structure can be an appearance feature of the opaque body, such as C-shaped, U-shaped, straight-shaped, etc., but the present disclosure is not limited thereto. The light blocking structure can be arranged on the non-closed ring structure substantially along a circumferential direction surrounding the exiting optical axis.

Each of the light blocking structures can extend towards the exiting optical axis and gradually shrink and intersect. Therefore, the light blocking performance of the light blocking structures can be enhanced.

The opaque body and the light blocking structures can be formed integrally. Therefore, the assembling process between the opaque body and the light blocking structures can be eliminated to make the manufacturing process faster.

When the exiting optical axis as the center of circle is taken, the angle occupied by the light blocking structures is θe, and a number of the light blocking structures is Ne, the following conditions are satisfied: 10 degrees<θe<150 degrees; and 15<Ne<250. Therefore, the reflection path of non-imaging light on the surface of specific location of the opaque body can be destroyed, so that the non-imaging light cannot enter the imaging lens assembly, thereby improving the image quality. Specifically, the light blocking structures can be arranged at the non-closed ring structure along the straight-shaped.

When the exiting optical axis as the center of circle is taken, the angle occupied by the light blocking structures is θe, and the number of the light blocking structures is Ne, the following conditions are satisfied: 110 degrees<θe<350 degrees; and 50<Ne<300. Therefore, the light blocking requirement of different optical designs can be satisfied so as to improve the optical design margin. Specifically, the light blocking structures can be arranged at the non-closed ring structure along U-shaped.

Each of the light blocking structures is a wedge-shaped protrusion. When the wedge-shaped protrusion has an included angle θe′, the following condition is satisfied: 0 degrees<θe′<90 degrees. Therefore, it is favorable for destroying the reflection path of non-imaging light by the shape design of the wedge-shaped protrusion so as to improve the light blocking effect. Specifically, the opaque body can be a holder or a carrier formed by plastic injection molding, which is transferred into the wedge-shaped or the semi-cylindrical appearance of each of the light blocking structures by the mold. The opaque body can also be a light blocking sheet formed by stamping manufacturing process, which is cut into the wedge-shaped or the petal shaped appearance of each of the light blocking structures via the mold, but the present disclosure is not limited thereto.

Each of the light blocking structures forms a convex arc. When the convex arc has a curvature radius Re, the following condition is satisfied: 0 mm<Re<0.3 mm. Therefore, it is favorable for destroying the reflection path of non-imaging light so as to improve the light blocking effect.

Each of the light blocking structures forms a concave arc. When the concave arc has a curvature radius Re′, the following condition is satisfied: 0 mm<Re′<0.3 mm. Therefore, it is favorable for destroying the reflection path of non-imaging light so as to improve the light blocking effect.

The non-closed ring structure can further include at least one auxiliary arc, and at least one portion of the light blocking structures is disposed on the auxiliary arc. When the auxiliary arc has a curvature radius r, the following condition is satisfied: 0.5 mm<r<50 mm. Therefore, the flare at the specific angle can be eliminated to make the image being clear. Specifically, each light blocking structure (including the wedge-shaped protrusion, the convex arc, the concave arc or the convex arc and the concave arc arranged continuously) can be further disposed at the auxiliary arc.

When a height of each of the light blocking structures extending along the direction perpendicular to the exiting optical axis is He, the following condition is satisfied: 0.01 mm<He<1.2 mm. Therefore, the height extension range with the better light blocking effect is achieved.

When a length of each of the light blocking structures extending along a direction parallel to the exiting optical axis is Le, the following condition is satisfied: 0.01 mm<Le<2.8 mm. Therefore, the length extension range with the better light blocking effect is achieved.

Furthermore, the light path folding element can be made of plastic material, and the opaque body can be made of black plastic material, but the present disclosure is not limited thereto.

The present disclosure provides a light path folding module, including a light path folding element and an opaque body, wherein the opaque body is disposed relative to the light path folding element. The light path folding element is for folding an incident optical axis to an exiting optical axis, and the light path folding element includes a light incident surface and a light exiting surface. The incident optical axis passes through and enters into the light incident surface. The exiting optical axis passes through and is away from the light exiting surface. The opaque body includes a non-closed ring structure and a plurality of light blocking structures. The incident optical axis passes through a notch opening of the non-closed ring structure. The light blocking structures extend toward the incident optical axis from the non-closed ring structure along a direction perpendicular to the incident optical axis, wherein the light blocking structures are disposed adjacent to the light incident surface of the light path folding element. When the incident optical axis as a center of circle, an angle occupied by the light blocking structures is θi, and a number of the light blocking structures is Ni, the following conditions are satisfied: 10 degrees<θi<350 degrees; and 15<Ni<460. Therefore, the non-imaging light outside the field of view can be blocked by arranging the light blocking structure toward the direction of the incident optical axis so as to maintain the image being clear.

Each of the light blocking structures can extend toward the incident optical axis and gradually shrink and intersect. Therefore, the light blocking performance of the light blocking structures can be enhanced.

The opaque body and the light blocking structures can be formed integrally. Therefore, the assembling process between the opaque body and the light blocking structures can be eliminated to make the manufacturing process faster.

When the incident optical axis as the center of circle is taken, the angle occupied by the light blocking structures is θi, and a number of the light blocking structures is Ni, the following conditions are satisfied: 10 degrees<θi<150 degrees; and 15<Ni<250. Therefore, the reflection path of non-imaging light on the surface of specific location of the opaque body can be destroyed, so that non-imaging light cannot enter the imaging lens assembly, thereby improving the image quality. Specifically, the light blocking structures can be arranged at the non-closed ring structure along straight-shaped.

When the incident optical axis as the center of circle is taken, the angle occupied by the light blocking structures is θi, and the number of the light blocking structures is Ni, the following conditions are satisfied: 110 degrees<θi<350 degrees; and 50<Ni<300. Therefore, the light blocking requirement of different optical designs can be satisfied so as to improve the optical design margin. Specifically, the light blocking structures can be arranged at the non-closed ring structure along U-shaped.

Each of the light blocking structures is a wedge-shaped protrusion. When the wedge-shaped protrusion has an included angle θi′, the following condition is satisfied: 0 degrees<θi′<90 degrees. Therefore, it is favorable for destroying the reflection path of non-imaging light by the shape design of the wedge-shaped protrusion so as to improve the light blocking effect.

Each of the light blocking structures forms a convex arc. When the convex arc has a curvature radius Ri, the following condition is satisfied: 0 mm<Ri<0.3 mm. Therefore, it is favorable for destroying the reflection path of non-imaging light so as to improve the light blocking effect.

Each of the light blocking structures forms a concave arc. When the concave arc has a curvature radius Ri′, the following condition is satisfied: 0 mm<Ri′<0.3 mm. Therefore, it is favorable for destroying the reflection path of non-imaging light so as to improve the light blocking effect.

The non-closed ring structure can further include at least one auxiliary arc, and at least one portion of the light blocking structures is disposed on the auxiliary arc. When the auxiliary arc has a curvature radius r, the following condition is satisfied: 0.5 mm<r<50 mm. Therefore, the flare at the specific angle can be eliminated to make the image being clear. Specifically, each light blocking structure (including the wedge-shaped protrusion, the convex arc, the concave arc or the convex arc and the concave arc arranged continuously) can be further disposed at the auxiliary arc.

When a height of each of the light blocking structures extending along the direction perpendicular to the incident optical axis is Hi, the following condition is satisfied: 0.01 mm<Hi<1.2 mm. Therefore, the height extension range with the better light blocking effect is achieved.

When a length of each of the light blocking structures extending along a direction parallel to the incident optical axis is Li, the following condition is satisfied: 0.01 mm<Li<2.8 mm. Therefore, the length extension range with the better light blocking effect is achieved.

Furthermore, the light path folding element can be made of plastic material, and the opaque body can be made of black plastic material, but the present disclosure is not limited thereto.

It must be noted that, in the opaque body of the light path folding module of the present disclosure, the light blocking structures are not limited to being disposed adjacent to one of the light incident surface and the light exiting surface of the light path folding element. The light blocking structures also can be disposed adjacent to the light incident surface and the light exiting surface of the light path folding element at the same time.

The present disclosure provides a camera module, which includes the light path folding module as described in any of the foregoing aspects and an imaging lens assembly, wherein the imaging lens assembly is disposed adjacent to the light path folding module.

The present disclosure provides an electronic device, including the camera module as described in any of the foregoing aspects and an image sensor, wherein the image sensor is disposed on an imaging surface of the camera module.

### 1st Embodiment

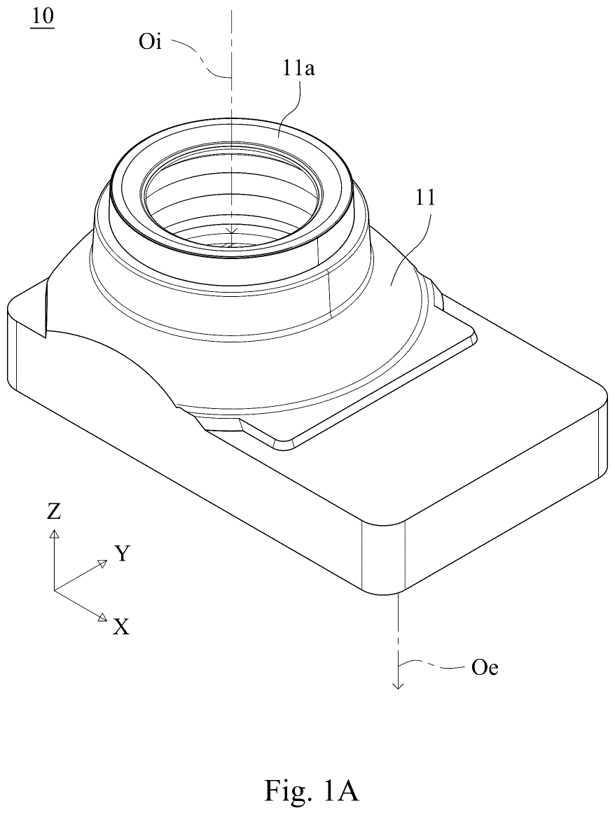

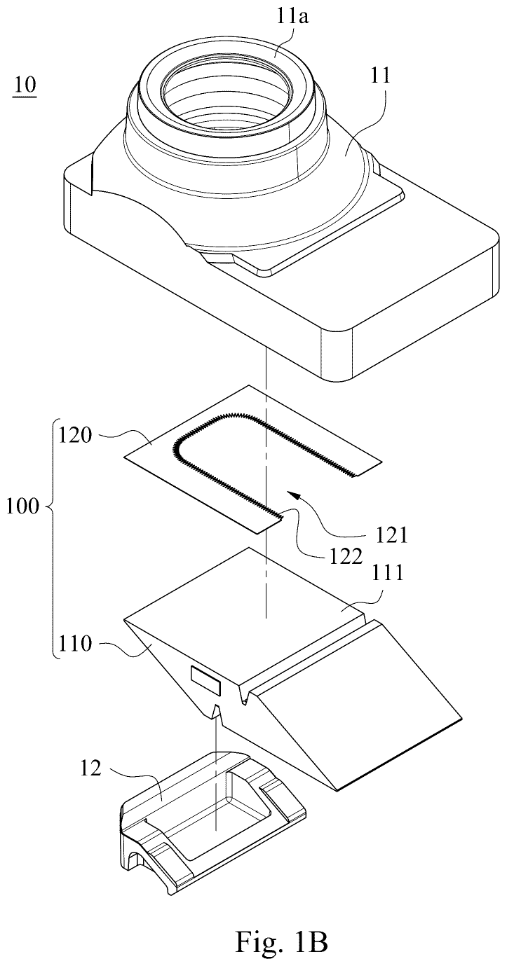

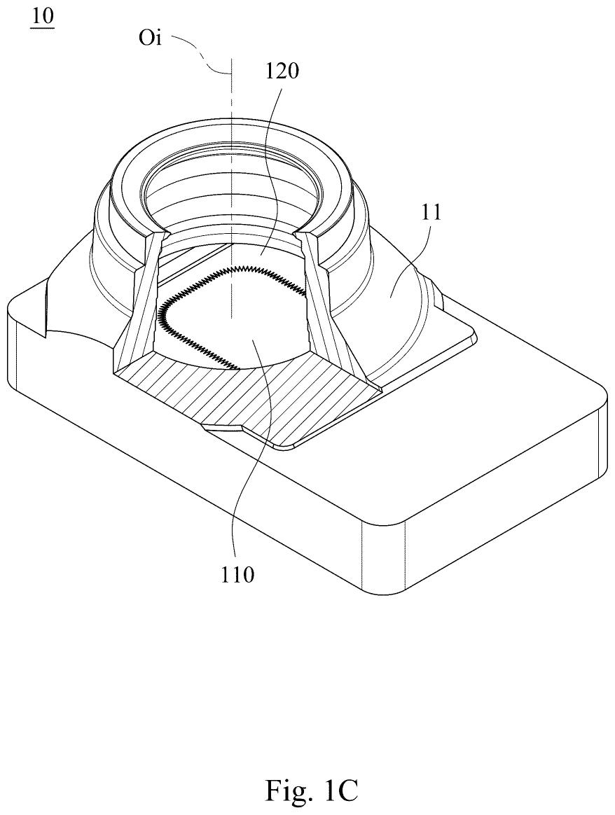

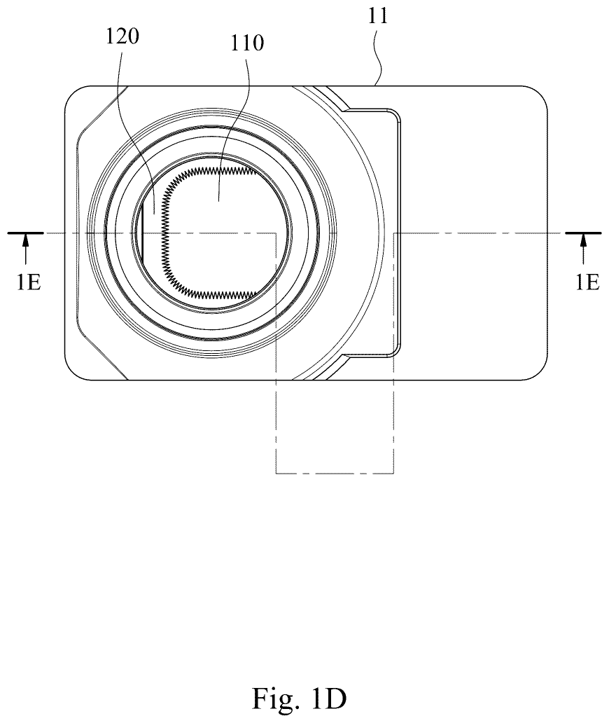

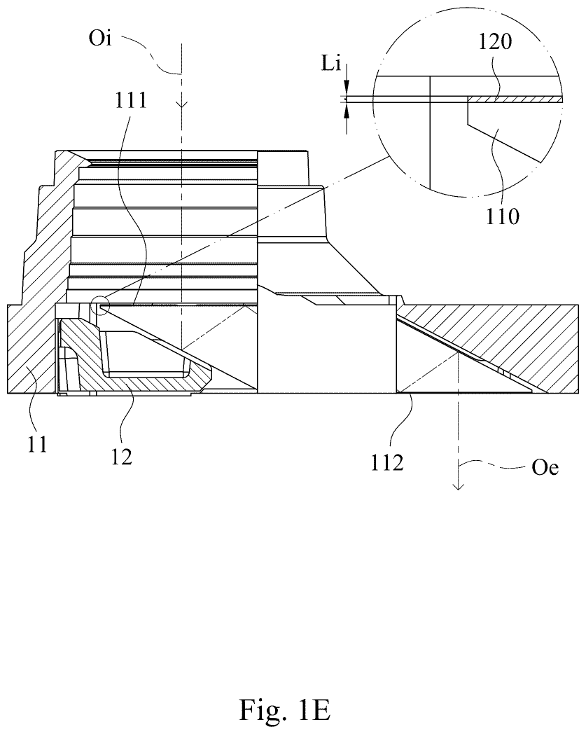

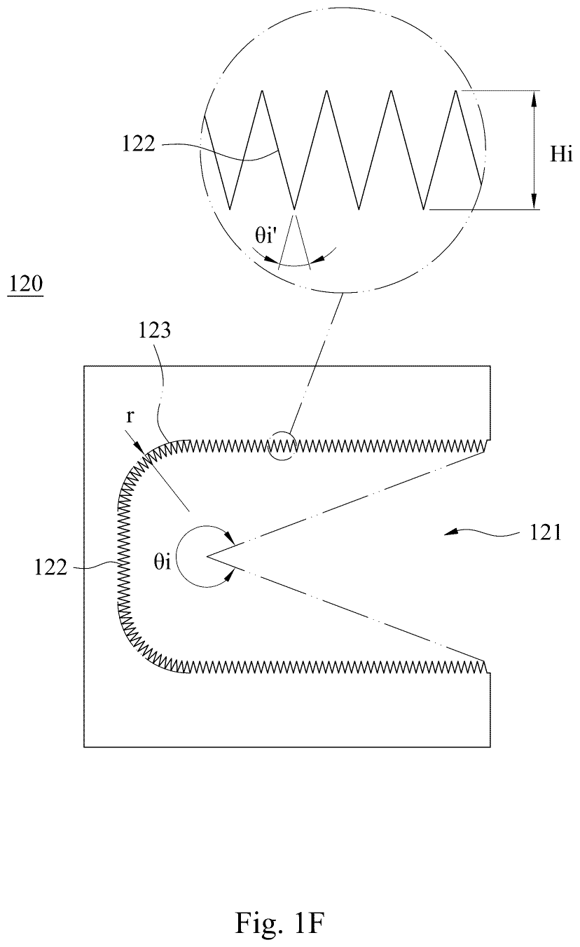

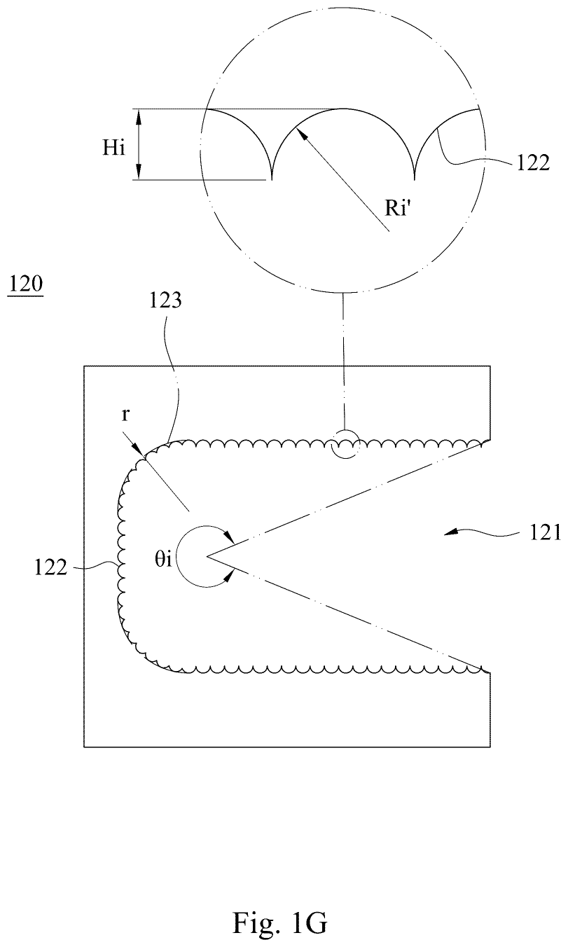

FIG. 1A is a three-dimensional schematic view of a camera module 10 of the 1st Example according to the 1st Embodiment of the present disclosure. FIG. 1B is an exploded view of the camera module 10 of the 1st Example according to the 1st Embodiment in FIG. 1A. FIG. 1C is a cross-sectional view of partial of the camera module 10 of the 1st Example according to the 1st Embodiment in FIG. 1A. In FIG. 1A, FIG. 1B and FIG. 1C, the camera module 10 includes a light path folding module 100 and an imaging lens assembly 11, wherein the imaging lens assembly 11 is disposed adjacent to the light path folding module 100. The light path folding module 100 is disposed on an image side of the imaging lens assembly 11 via an assembling component 12. Specifically, the light path folding module 100 includes a light path folding element 110 and an opaque body 120, wherein the imaging lens assembly 11 includes a lens barrel portion 11a for accommodating at least one imaging lens element (not shown in drawings), which is not a technical key point of the present disclosure and will not be described herein.

FIG. 1D is a plane view of the camera module 10 of the 1st Example according to the 1st Embodiment in FIG. 1A. FIG. 1E is a cross-sectional view along line 1E-1E in FIG. 1D. In FIG. 1A to FIG. 1E, the light path folding element 110 of the light path folding module 100 is disposed relative to the opaque body 120. The light path folding element 110 is for folding an incident optical axis Oi to an exiting optical axis Oe, which includes a light incident surface 111 and a light exiting surface 112. The incident optical axis Oi passes through and enters into the light incident surface 111. The exiting optical axis Oe passes through and is away from the light exiting surface 112. Specifically, the direction parallel to the exiting optical axis Oe is the Z axis. The direction perpendicular to the exiting optical axis Oe is any direction on an XY plane defined by the X axis and the Y axis. In the 1st Example of the 1st Embodiment, the light path folding element 110 is a prism.

The opaque body 120 includes a non-closed structure (its reference numeral is omitted) and a plurality of light blocking structures 122. The incident optical axis Oi passes through a notch opening 121 of the non-closed ring structure. The light blocking structures 122 extend towards the incident optical axis Oi from the non-closed ring structure along a direction perpendicular to the incident optical axis Oi, wherein the light blocking structures 122 are disposed adjacent to the light incident surface 111 of the light path folding element 110. Specifically, the light blocking structures 122 are arranged on the non-closed ring structure substantially along a circumferential direction surrounding the incident optical axis Oi. Furthermore, the opaque body 120 and the light blocking structures 122 are formed integrally.

FIG. 1F is a plane view of the opaque body 120 of the 1st Example according to the 1st Embodiment in FIG. 1A. In FIG. 1C and FIG. 1F, each of the light blocking structures 122 extends towards the incident optical axis Oi and gradually shrinks and intersects. Each of the light blocking structures 122 is a wedge-shaped protrusion. The non-closed ring structure can further include two auxiliary arcs 123, and the portion of the light blocking structures 122 is disposed on the auxiliary arcs 123.

Furthermore, in the 1st Example of the 1st Embodiment, the light path folding element 110 is made of plastic material. The opaque body 120 is made of black plastic material.

In FIG. 1E and FIG. 1F, according to the 1st Example of the 1st Embodiment, when the incident optical axis Oi as a center of circle is taken, an angle occupied by the light blocking structures 122 is θi, a number of the light blocking structures 122 is Ni, the wedge-shaped protrusion has an included angle θi′, the auxiliary arc 123 has a curvature radius r, a height of each of the light blocking structures 122 extending along the direction perpendicular to the incident optical axis Oi is Hi, a length of each of the light blocking structures 122 extending along a direction parallel to the incident optical axis Oi is Li, the following conditions shown in Table 1A are satisfied.

TABLE 1A
1st Example of 1st Embodiment

| | | | |
|---|---|---|---|
| θi (degrees) | 318.6 | r (mm) | 1.50 |
| Ni | 141 | Hi (mm) | 0.25 |
| θi′ (degrees) | 30 | Li (mm) | 0.02 |

FIG. 1G is a plane view of the opaque body 120 of the 2nd Example according to the 1st Embodiment in FIG. 1A. It must be noted that the difference between the 2nd Example of the 1st Embodiment of the present disclosure and the 1st Example thereof is only in the shape of the opaque body 120, and the other components, positions and connection relationships are the same or similar, which will not be described herein. In FIG. 1C and FIG. 1G, according to the 2nd Example of the 1st Embodiment, each of the light blocking structures 122 extends towards the incident optical axis Oi and gradually shrinks and intersects. Each of the light blocking structures 122 is petal-shaped. Each of the light blocking structures 122 forms a concave arc (its reference numeral is omitted). The non-closed ring structure can further include two auxiliary arcs 123, and the portion of the light blocking structures 122 is disposed on the auxiliary arcs 123.

In FIG. 1E and FIG. 1G, according to the 2nd Example of the 1st Embodiment, when the incident optical axis Oi as a center of circle is taken, an angle occupied by the light blocking structures 122 is θi, a number of the light blocking structures 122 is Ni, the concave arc has a curvature radius Re′, the auxiliary arc 123 has a curvature radius r, a height of each of the light blocking structures 122 extending along the direction perpendicular to the incident optical axis Oi is Hi, a length of each of the light blocking structures 122 extending along a direction parallel to the incident optical axis Oi is Li, the following conditions shown in Table 1B are satisfied.

TABLE 1B
2nd Example of 1st Embodiment

| | | | |
|---|---|---|---|
| θi (degrees) | 315.3 | r (mm) | 1.50 |
| Ni | 65 | Hi (mm) | 0.15 |
| Ri′ (mm) | 0.15 | Li (mm) | 0.02 |

### 2nd Embodiment

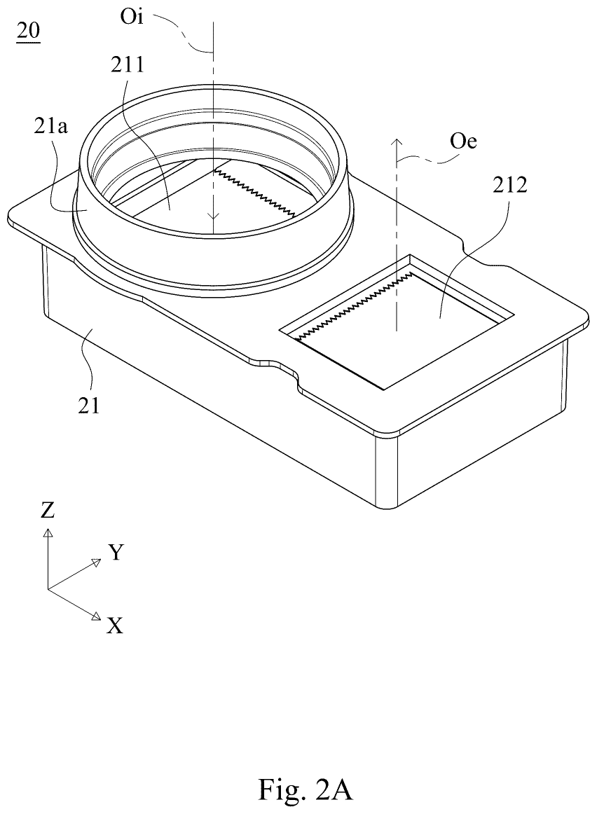

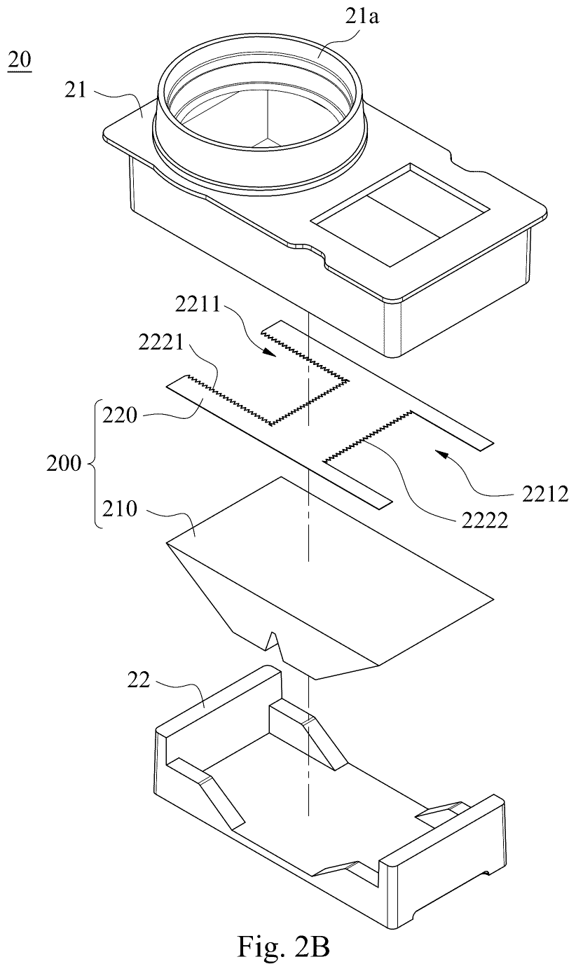

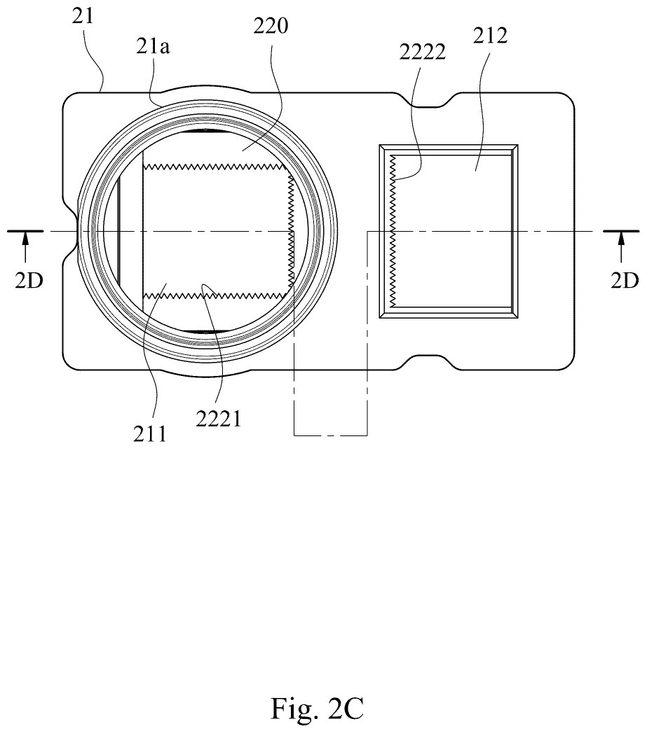

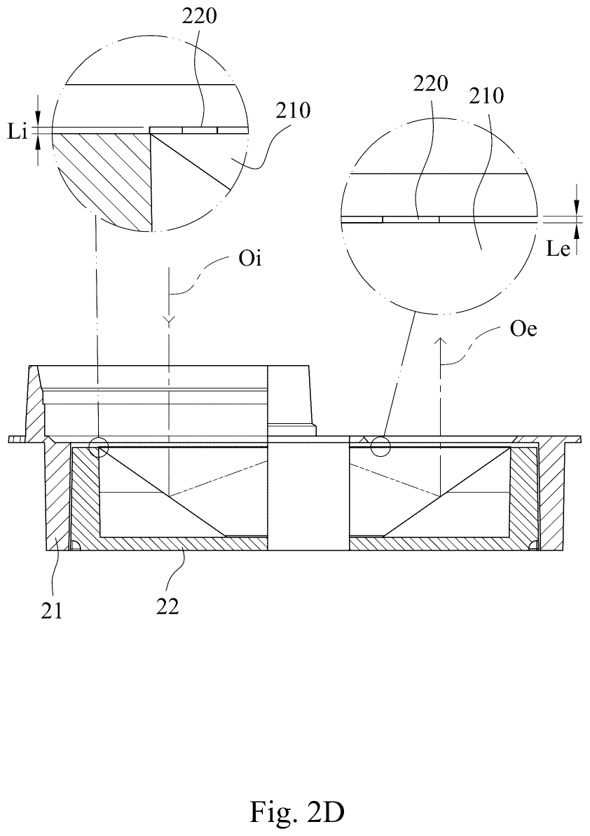

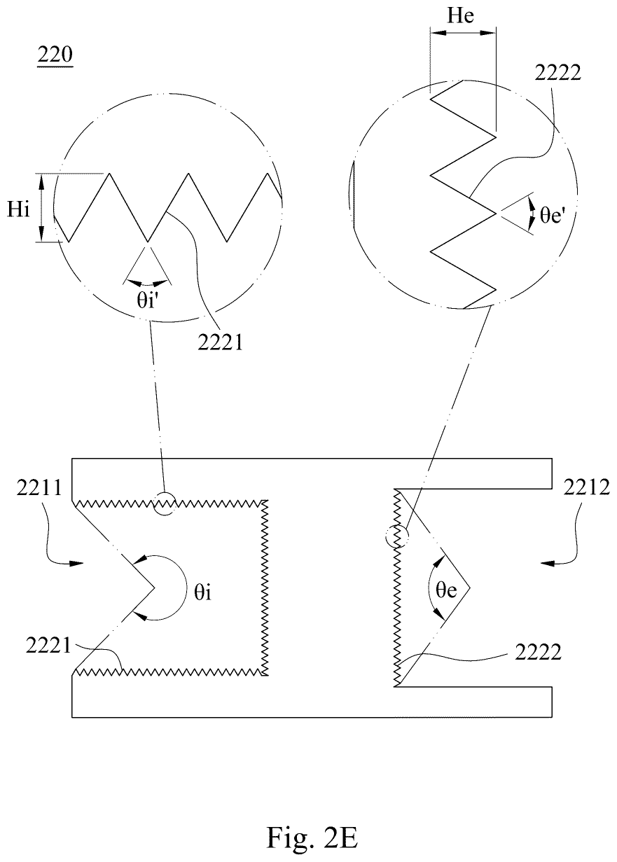

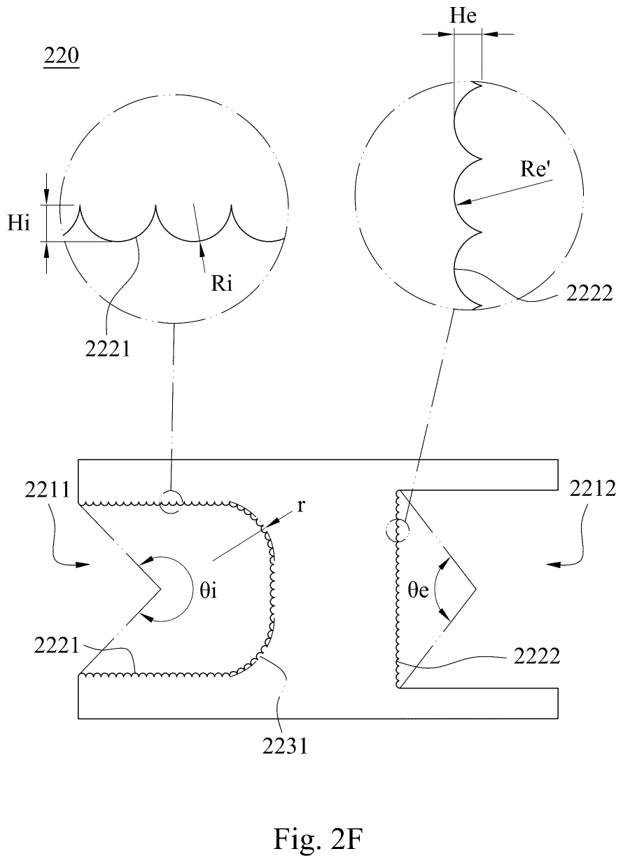

FIG. 2A is a three-dimensional view of a camera module 20 of the 1st Example according to the 2nd Embodiment of the present disclosure. FIG. 2B is an exploded view of the camera module 20 of the 1st Example according to the 2nd Embodiment in FIG. 2A. In FIG. 2A and FIG. 2B, the camera module 20 includes a light path folding module 200 and an imaging lens assembly 21, wherein the imaging lens assembly 21 is disposed adjacent to the light path folding module 200. The light path folding module 200 is disposed on an image side of the imaging lens assembly 21 via an assembling component 22. Specifically, the light path folding module 200 includes a light path folding element 210 and an opaque body 220, wherein the imaging lens assembly 21 includes a lens barrel portion 21a for accommodating at least one imaging lens element (not shown in drawings), which is not a technical key point of the present disclosure and will not be described herein.

FIG. 2C is a plane view of the camera module 20 of the 1st Example according to the 2nd Embodiment in FIG. 2A. FIG. 2D is a cross-sectional view along line 2D-2D in FIG. 2C. In FIG. 2A to FIG. 2D, the light path folding element 210 of the light path folding module 200 is disposed relative to the opaque body 220. The light path folding element 210 is for folding an incident optical axis Oi to an exiting optical axis Oe, which includes a light incident surface 211 and a light exiting surface 212. The incident optical axis Oi passes through and enters into the light incident surface 211. The exiting optical axis Oe passes through and is away from the light exiting surface 212. Specifically, in the 1st Example of the 2nd Embodiment of the present disclosure, the light path folding element 210 is a prism, and the light incident surface 211 and the light exiting surface 212 are both located on the same surface of the light path folding element 210.

The opaque body 220 includes two non-closed structures (its reference numeral is omitted) and a plurality of light blocking structures 2221, 2222. The incident optical axis Oi passes through a notch opening 2211 of the non-closed ring structure. The light blocking structures 2221 extend towards the incident optical axis Oi from the non-closed ring structure along a direction perpendicular to the incident optical axis Oi, wherein the light blocking structures 2221 are disposed adjacent to the light incident surface 211 of the light path folding element 210. The exiting optical axis Oe passes through a notch opening 2212 of the non-closed ring structure. The light blocking structures 2222 extend towards the exiting optical axis Oe from the non-closed ring structure along a direction perpendicular to the exiting optical axis Oe, wherein the light blocking structures 2222 are disposed adjacent to the light exiting surface 212 of the light path folding element 210. Furthermore, the opaque body 220 and the light blocking structures 2221, 2222 are formed integrally.

FIG. 2E is a plane view of the opaque body 220 of the 1st Example according to the 2nd Embodiment in FIG. 2A. In FIG. 2E, each of the light blocking structures 2221 extends towards the incident optical axis Oi and gradually shrinks and intersects. Each of the light blocking structures 2221 is a wedge-shaped protrusion. Each of the light blocking structures 2222 extends towards the exiting optical axis Oe and gradually shrinks and intersects. Each of the light blocking structures 2222 is a wedge-shaped protrusion.

Furthermore, in the 1st Example of the 2nd Embodiment, the light path folding element 210 is made of plastic material. The opaque body 220 is made of black plastic material.

In FIG. 2D and FIG. 2E, according to the 1st Example of the 2nd Embodiment, when the incident optical axis Oi as a center of circle is taken, an angle occupied by the light blocking structures 2221 is θi, a number of the light blocking structures 2221 is Ni, the wedge-shaped protrusion of the light blocking structures 2221 has an included angle θi′, a height of each of the light blocking structures 2221 extending along the direction perpendicular to the incident optical axis Oi is Hi, a length of each of the light blocking structures 2221 extending along a direction parallel to the incident optical axis Oi is Li; when the exiting optical axis Oe as a center of circle is taken, an angle occupied by the light blocking structures 2222 is θe, a number of the light blocking structures 2222 is Ne, the wedge-shaped protrusion of the light blocking structures 2222 has an included angle θe′, a height of each of the light blocking structures 2222 extending along the direction perpendicular to the exiting optical axis Oe is He, a length of each of the light blocking structures 2222 extending along a direction parallel to the exiting optical axis Oe is Le, the following conditions shown in Table 2A are satisfied.

TABLE 2A
1st Example of 2nd Embodiment

| | | | |
|---|---|---|---|
| θi (degrees) | 268.6 | θe (degrees) | 107.7 |
| Ni | 74 | Ne | 26 |
| θi′ (degrees) | 59.5 | θe′ (degrees) | 60 |
| Hi (mm) | 0.18 | He (mm) | 0.17 |
| Li (mm) | 0.02 | Le (mm) | 0.02 |

FIG. 2F is a plane view of the opaque body 220 of the 2nd Example according to the 2nd Embodiment in FIG. 2A. It must be noted that the difference between the 2nd Example of the 2nd Embodiment of the present disclosure and the 1st Example thereof is only in the shape of the opaque body 220, and the other components, positions and connection relationships are the same or similar, which will not be described herein. In FIG. 2F, according to the 2nd Example of the 2nd Embodiment, each of the light blocking structures 2221 is a petal shaped and forms a convex arc (its reference numeral is omitted). The non-closed ring structure can further include two auxiliary arcs 2231, and the portion of the light blocking structures 2221 is disposed on the auxiliary arcs 2231. Each of the light blocking structures 2222 is petal-shaped and forms a concave arc (its reference numeral is omitted).

In FIG. 2D and FIG. 2F, according to the 2nd Example of the 2nd Embodiment, when the incident optical axis Oi as a center of circle is taken, an angle occupied by the light blocking structures 2221 is θi, a number of the light blocking structures 2221 is Ni, the convex arc has a curvature radius Ri, the auxiliary arc 2231 has a curvature radius r, a height of each of the light blocking structures 2221 extending along the direction perpendicular to the incident optical axis Oi is Hi, a length of each of the light blocking structures 2221 extending along a direction parallel to the incident optical axis Oi is Li; when the exiting optical axis Oe as a center of circle is taken, an angle occupied by the light blocking structures 2222 is θe, a number of the light blocking structures 2222 is Ne, the concave arc has a curvature radius Re′, a height of each of the light blocking structures 2222 extending along the direction perpendicular to the exiting optical axis Oe is He, a length of each of the light blocking structures 2222 extending along a direction parallel to the exiting optical axis Oe is Le, the following conditions shown in Table 2B are satisfied.

TABLE 2B
2nd Example of 2nd Embodiment

| | | | |
|---|---|---|---|
| θi (degrees) | 268.2 | θe (degrees) | 104.9 |
| Ni | 66 | Ne | 27 |
| Ri (mm) | 0.10 | Re′ (mm) | 0.10 |
| r (mm) | 1.61 | He (mm) | 0.07 |
| Hi (mm) | 0.10 | Le (mm) | 0.02 |
| Li (mm) | 0.02 | | |

### 3rd Embodiment

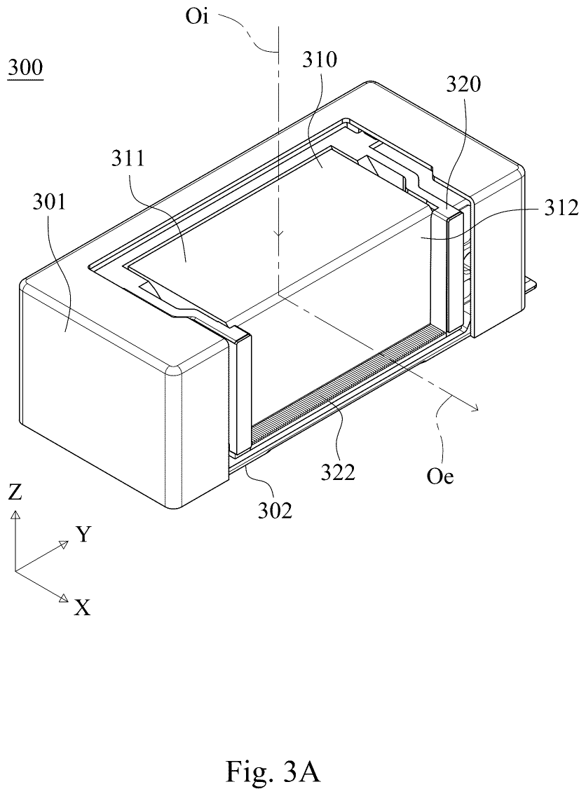

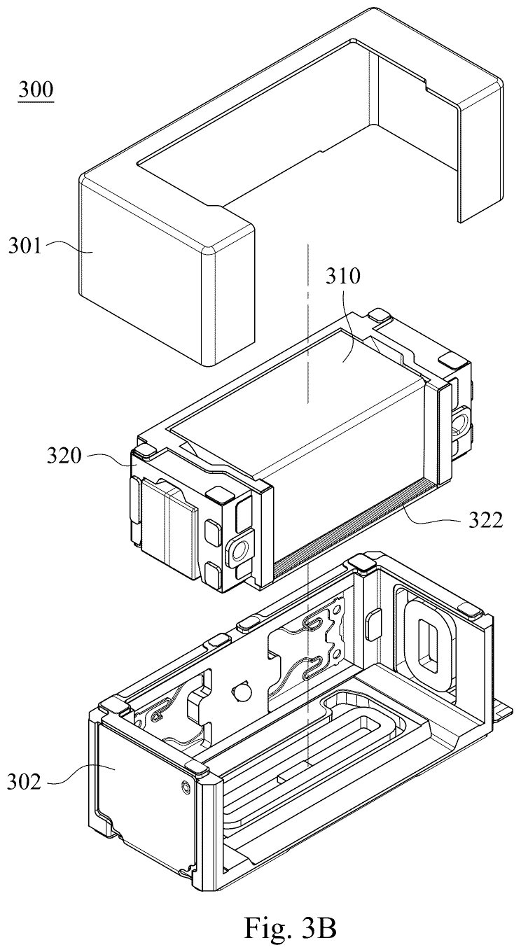

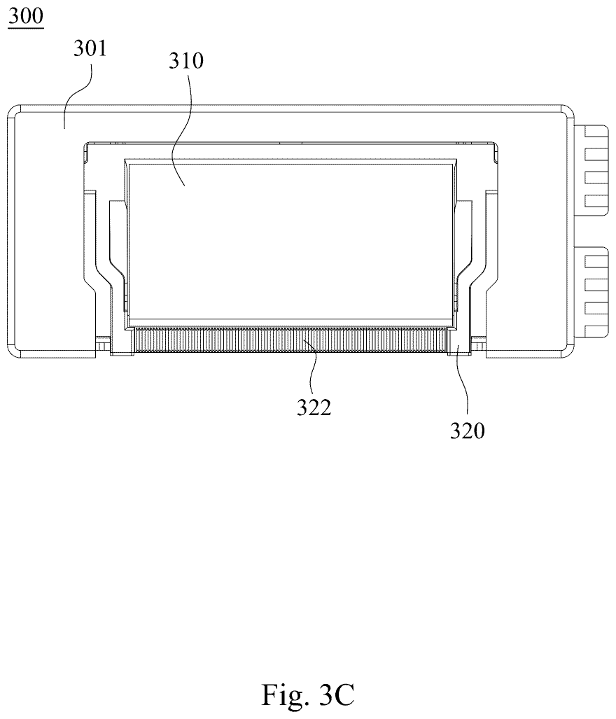

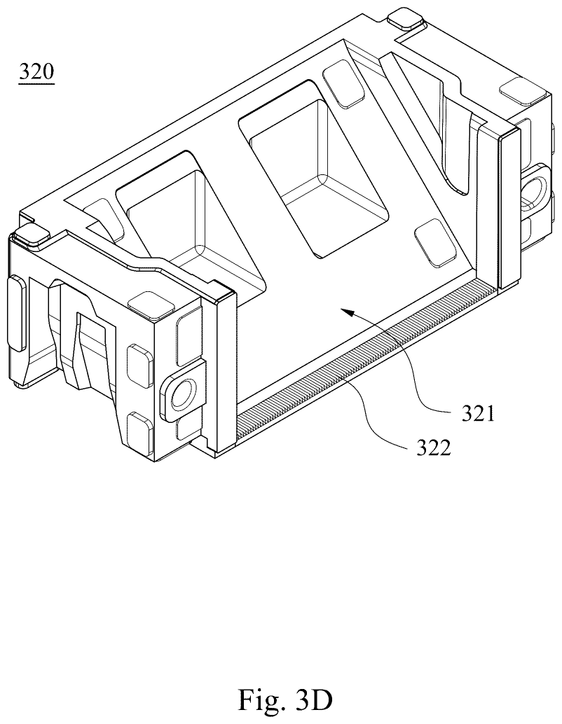

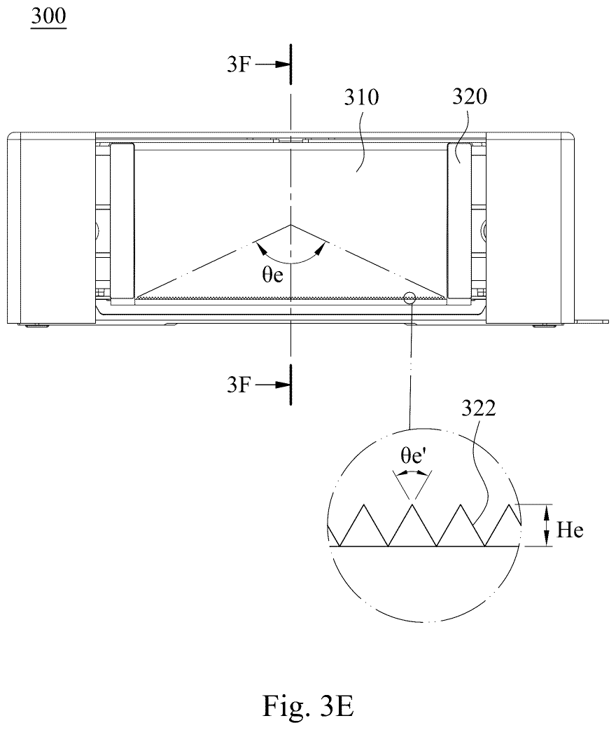

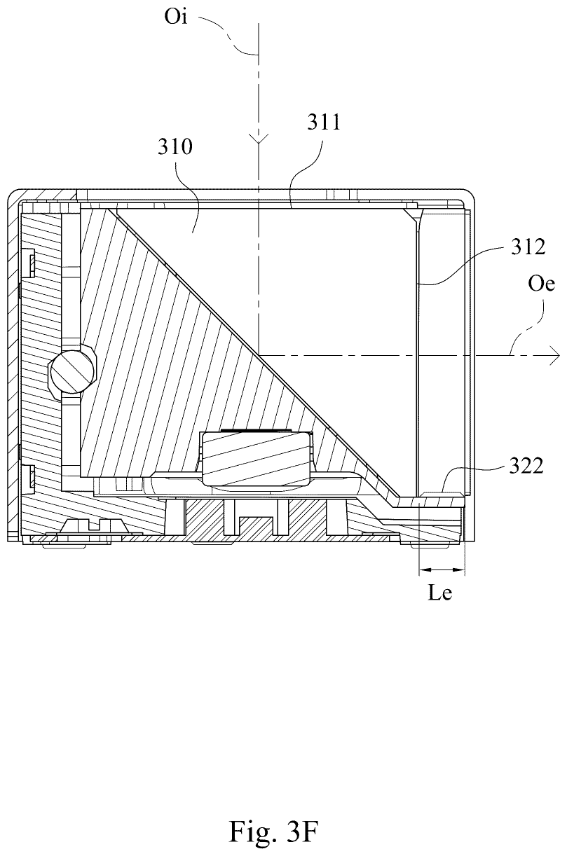

FIG. 3A is a schematic view of a light path folding module 300 of the 1st Example according to the 3rd Embodiment of the present disclosure. FIG. 3B is an exploded view of the light path folding module 300 of the 1st Example according to the 3rd Embodiment in FIG. 3A. FIG. 3C is a plane view of the light path folding module 300 of the 1st Example according to the 3rd Embodiment in FIG. 3A. In FIG. 3A, FIG. 3B and FIG. 3C, the light path folding module 300 includes a light path folding element 310 and an opaque body 320, wherein the opaque body 320 is disposed relative to the light path folding element 310. Furthermore, the light path folding module 300 can further include a cover 301 and an assembly carrier 302, wherein the opaque body 320 and the light path folding element 310 are disposed on the assembly carrier 302. The cover 301 covers the assembly carrier 302, which is favorable for the overall light path folding module 300 disposing in the camera module or other devices.

FIG. 3D is a schematic view of the opaque body 320 of the 1st Example according to the 3rd Embodiment in FIG. 3A. FIG. 3E is another plane view of the light path folding module 300 of the 1st Example according to the 3rd Embodiment in FIG. 3A. FIG. 3F is a cross-sectional view along line 3F-3F in FIG. 3E. In FIG. 3D to FIG. 3F, the light path folding element 310 is for folding an incident optical axis Oi to an exiting optical axis Oe, which includes a light incident surface 311 and a light exiting surface 312. The incident optical axis Oi passes through and enters into the light incident surface 311. The exiting optical axis Oe passes through and is away from the light exiting surface 312. In the 1st Example of the 3rd Embodiment, the light path folding element 310 is a prism.

The opaque body 320 includes a non-closed structure (its reference numeral is omitted) and a plurality of light blocking structures 322. The exiting optical axis Oe passes through a notch opening 321 of the non-closed ring structure. The light blocking structures 322 extend towards the exiting optical axis Oe from the non-closed ring structure along a direction perpendicular to the exiting optical axis Oe, wherein the light blocking structures 322 are disposed adjacent to the light exiting surface 312 of the light path folding element 310. Furthermore, the opaque body 320 and the light blocking structures 322 are formed integrally.

Each of the light blocking structures 322 extends towards the exiting optical axis Oe and gradually shrinks and intersects. Each of the light blocking structures 322 is a wedge-shaped protrusion.

Furthermore, in the 1st Example of the 3rd Embodiment, the light path folding element 310 is made of plastic material. The opaque body 320 is made of black plastic material.

In FIG. 3E and FIG. 3F, according to the 1st Example of the 3rd Embodiment, when the exiting optical axis Oe as a center of circle is taken, an angle occupied by the light blocking structures 322 is ee, a number of the light blocking structures 322 is Ne, the wedge-shaped protrusion has an included angle θe′, a height of each of the light blocking structures 322 extending along the direction perpendicular to the exiting optical axis Oe is He, a length of each of the light blocking structures 322 extending along a direction parallel to the exiting optical axis Oe is Le, the following conditions shown in Table 3A are satisfied.

TABLE 3A
1st Example of 3rd Embodiment

| | | | |
|---|---|---|---|
| θe (degrees) | 129.5 | He (mm) | 0.09 |
| Ne | 106 | Le (mm) | 0.85 |
| θe′ (degrees) | 60 | | |

### 4th Embodiment

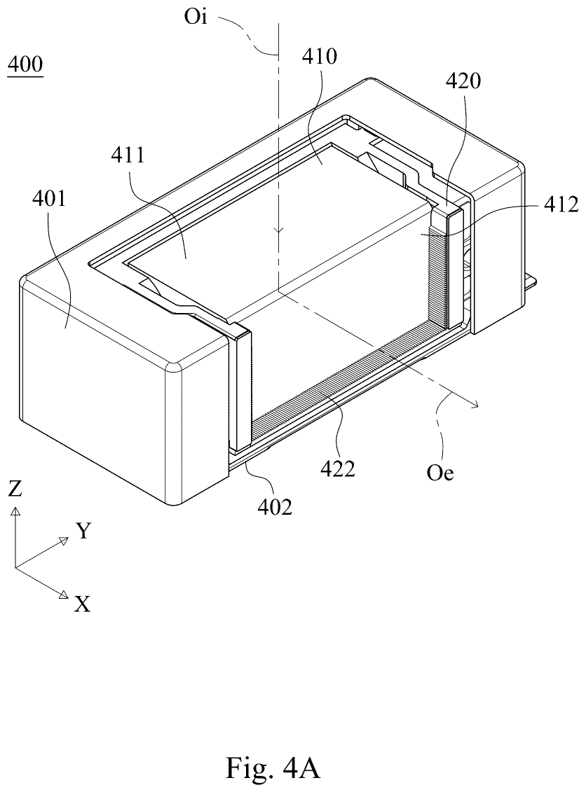

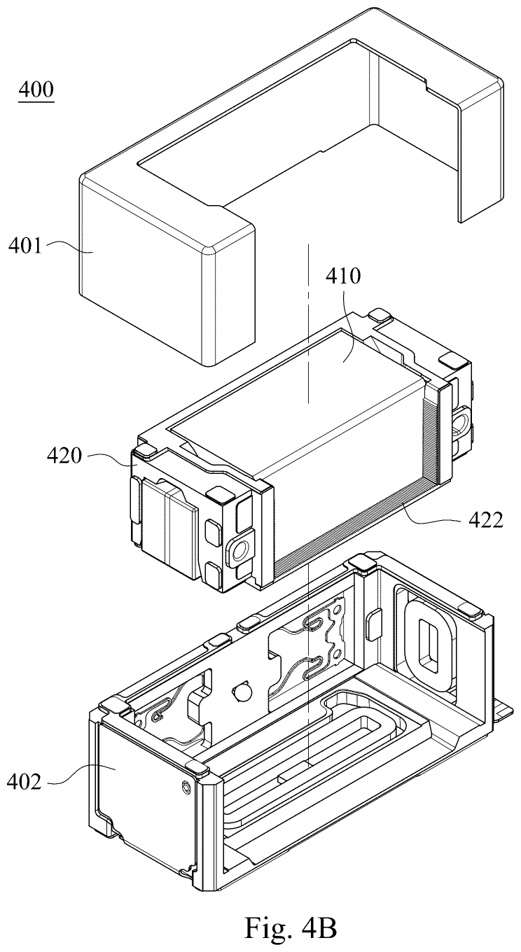

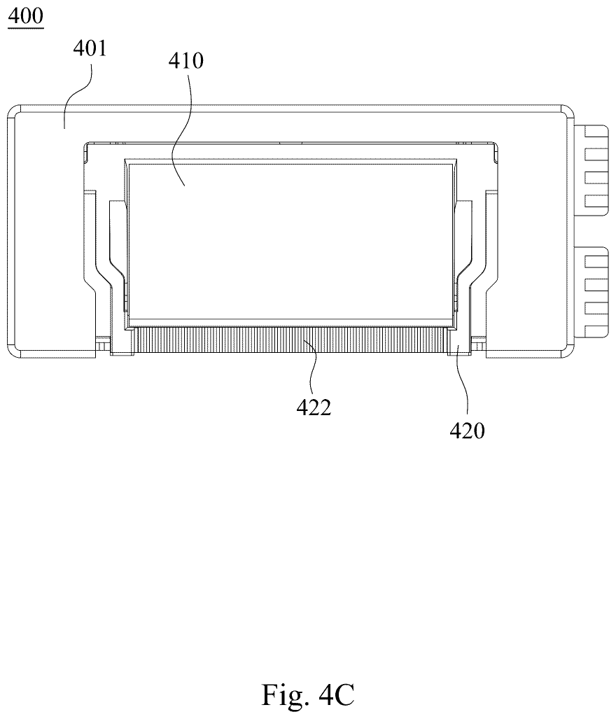

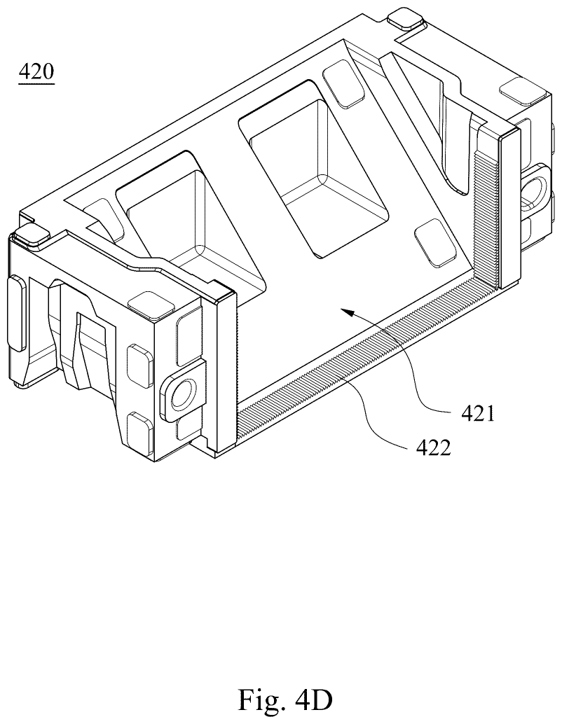

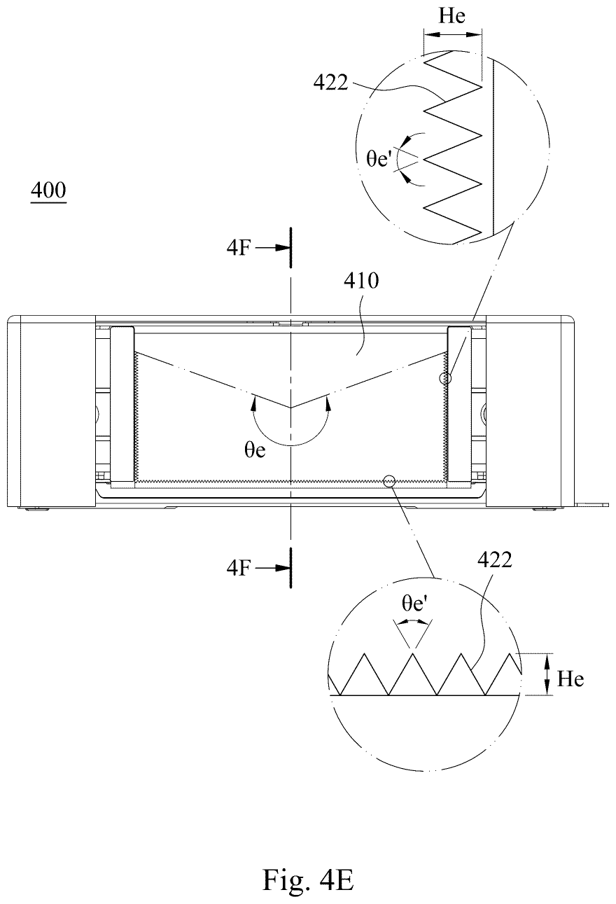

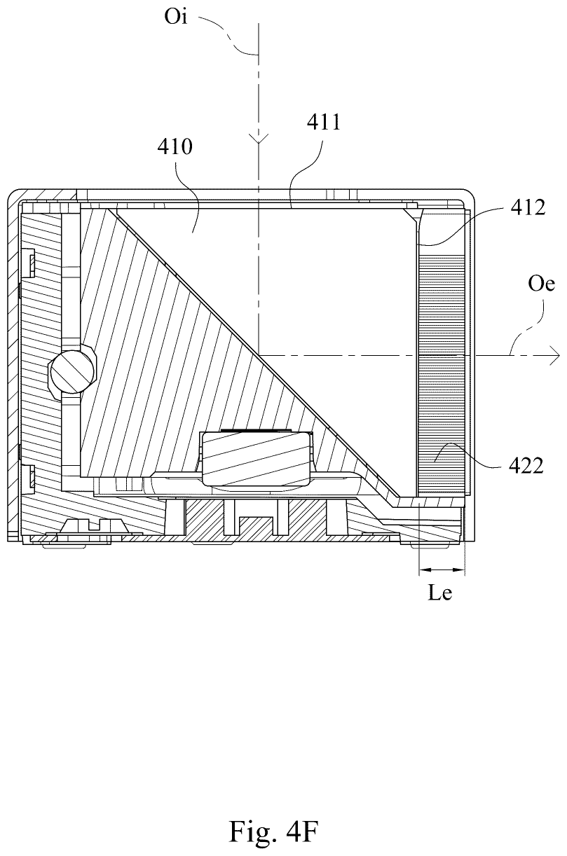

FIG. 4A is a schematic view of a light path folding module 400 of the 1st Example according to the 4th Embodiment of the present disclosure. FIG. 4B is an exploded view of the light path folding module 400 of the 1st Example according to the 4th Embodiment in FIG. 4A. FIG. 4C is a plane view of the light path folding module 400 of the 1st Example according to the 4th Embodiment in FIG. 4A. In FIG. 4A, FIG. 4B and FIG. 4C, the light path folding module 400 includes a light path folding element 410 and an opaque body 420, wherein the opaque body 420 is disposed relative to the light path folding element 410. Furthermore, the light path folding module 400 can further include a cover 401 and an assembly carrier 402, wherein the opaque body 420 and the light path folding element 410 are disposed on the assembly carrier 402. The cover 401 covers the assembly carrier 402, which is favorable for the overall light path folding module 400 disposing in the camera module or other devices.

FIG. 4D is a schematic view of the opaque body 420 of the 1st Example according to the 4th Embodiment in FIG. 4A. FIG. 4E is another plane view of the light path folding module 400 of the 1st Example according to the 4th Embodiment in FIG. 4A. FIG. 4F is a cross-sectional view along line 4F-4F in FIG. 4E. In FIG. 4D to FIG. 4F, the light path folding element 410 is for folding an incident optical axis Oi to an exiting optical axis Oe, which includes a light incident surface 411 and a light exiting surface 412. The incident optical axis Oi passes through and enters into the light incident surface 411. The exiting optical axis Oe passes through and is away from the light exiting surface 412. In the 1st Example of the 4th Embodiment, the light path folding element 410 is a prism.

The opaque body 420 includes a non-closed structure (its reference numeral is omitted) and a plurality of light blocking structures 422. The exiting optical axis Oe passes through a notch opening 421 of the non-closed ring structure. The light blocking structures 422 extend towards the exiting optical axis Oe from the non-closed ring structure along a direction perpendicular to the exiting optical axis Oe, wherein the light blocking structures 422 are disposed adjacent to the light exiting surface 412 of the light path folding element 410. Furthermore, the opaque body 420 and the light blocking structures 422 are formed integrally.

Each of the light blocking structures 422 extends towards the exiting optical axis Oe and gradually shrinks and intersects. Each of the light blocking structures 422 is a wedge-shaped protrusion. Specifically, the light blocking structures 422 is arranged on the non-closed ring structure substantially along a circumferential direction surrounding the exiting optical axis Oe. Furthermore, the light blocking structures 422 are generally arranged in a U-shaped distribution with the exiting optical axis Oe as a center. In the U-shaped distribution, the shape and the size of the light blocking structures 422 located at the bottom of the U-shaped and the light blocking structures 422 located at the both sides of the U-shaped are slightly different (the differences are shown in Table 4A as follows).

Furthermore, in the 1st Example of the 4th Embodiment, the light path folding element 410 is made of plastic material. The opaque body 420 is made of black plastic material.

In FIG. 4E and FIG. 4F, according to the 1st Example of the 4th Embodiment, when the exiting optical axis Oe as a center of circle is taken, an angle occupied by the light blocking structures 422 is θe, a number of the light blocking structures 422 is Ne, the wedge-shaped protrusion has an included angle θe′, a height of each of the light blocking structures 422 extending along the direction perpendicular to the exiting optical axis Oe is He, a length of each of the light blocking structures 422 extending along a direction parallel to the exiting optical axis Oe is Le, the following conditions shown in Table 4A are satisfied. It must be noted that, as shown in Table 4A, in the columns of θe′ and He, the value on the left side is the value of the light blocking structures 422 located at the both sides of the U-shaped, and the value on the right side is the value of the light blocking structures 422 located at the bottom of the U-shaped.

TABLE 4A
1st Example of 4th Embodiment

| | | | |
|---|---|---|---|
| θe (degrees) | 219.8 | He (mm) | 0.12, 0.09 |
| Ne | 194 | Le (mm) | 0.87 |
| θe′ (degrees) | 45, 60 | | |

### 5th Embodiment

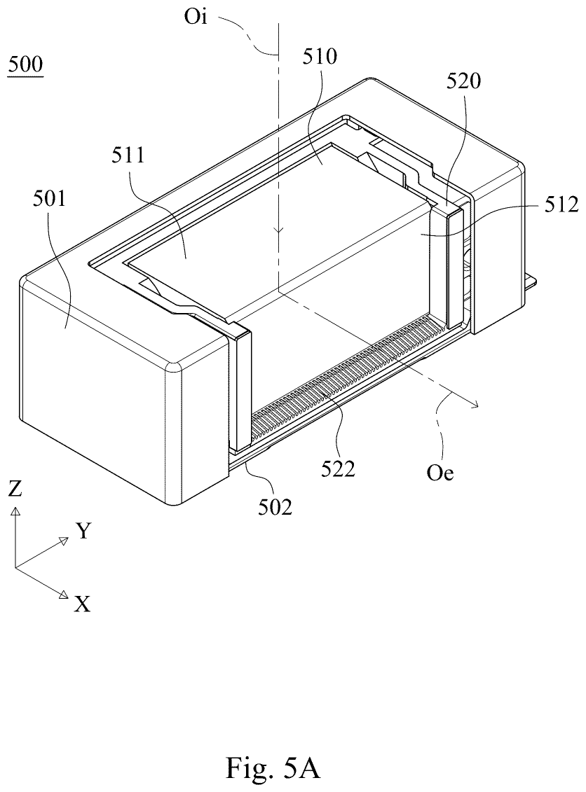

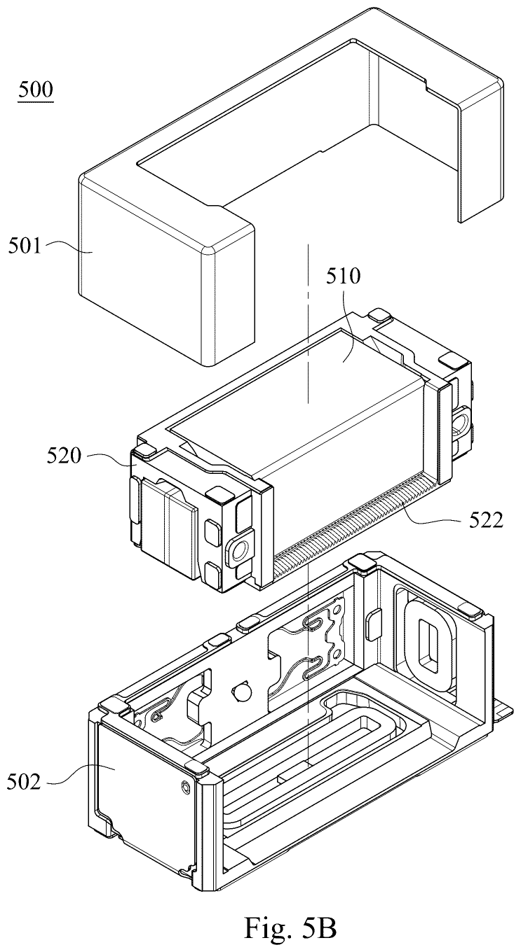

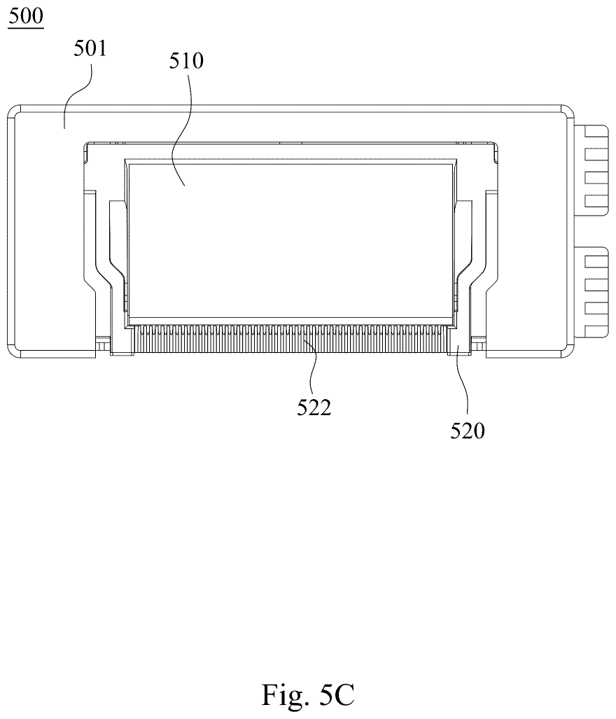

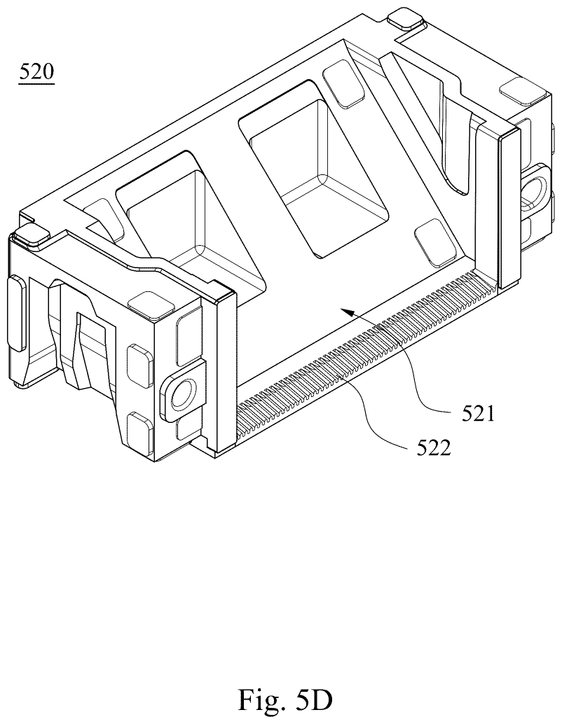

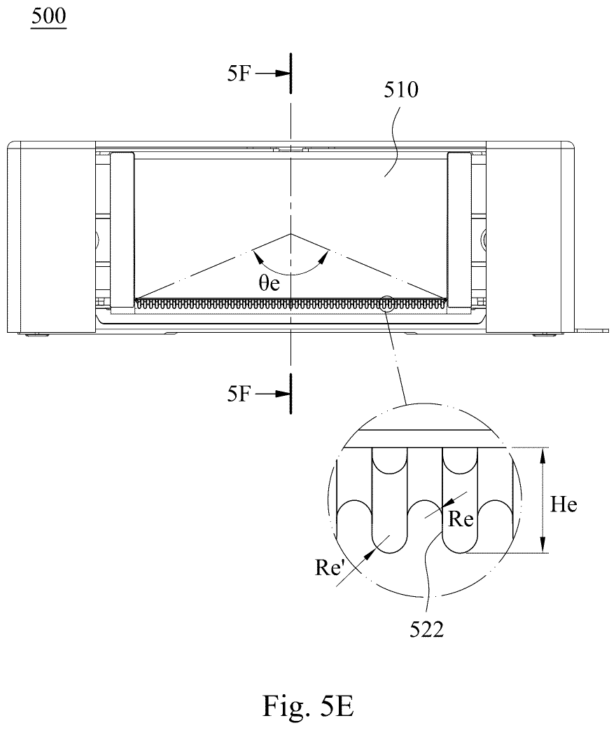

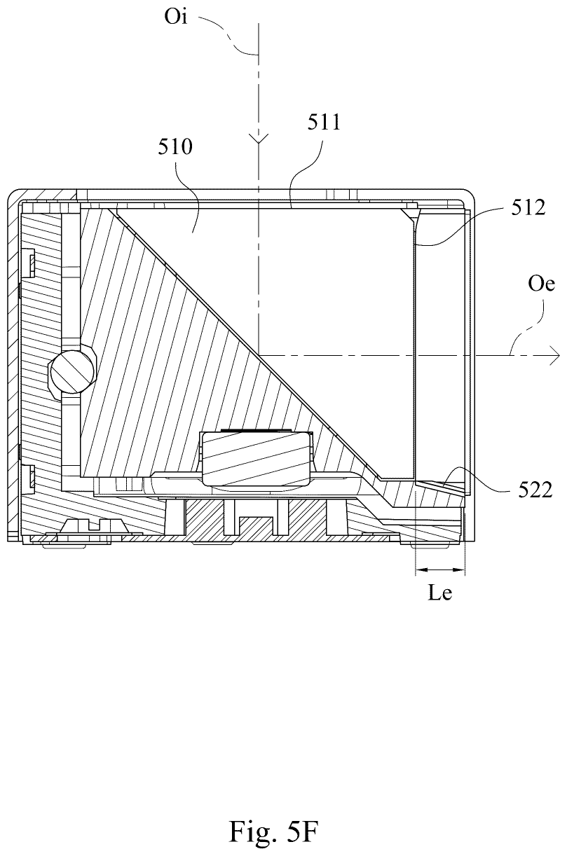

FIG. 5A is a schematic view of a light path folding module 500 of the 1st Example according to the 5th Embodiment of the present disclosure. FIG. 5B is an exploded view of the light path folding module 500 of the 1st Example according to the 5th Embodiment in FIG. 5A. FIG. 5C is a plane view of the light path folding module 500 of the 1st Example according to the 5th Embodiment in FIG. 5A. In FIG. 5A, FIG. 5B and FIG. 5C, the light path folding module 500 includes a light path folding element 510 and an opaque body 520, wherein the opaque body 520 is disposed relative to the light path folding element 510. Furthermore, the light path folding module 500 can further include a cover 501 and an assembly carrier 502, wherein the opaque body 520 and the light path folding element 510 are disposed on the assembly carrier 502. The cover 501 covers the assembly carrier 502, which is favorable for the overall light path folding module 500 disposing in the camera module or other devices.

FIG. 5D is a schematic view of the opaque body 520 of the 1st Example according to the 5th Embodiment in FIG. 5A. FIG. 5E is another plane view of the light path folding module 500 of the 1st Example according to the 5th Embodiment in FIG. 5A. FIG. 5F is a cross-sectional view along line 5F-5F in FIG. 5E. In FIG. 5D to FIG. 5F, the light path folding element 510 is for folding an incident optical axis Oi to an exiting optical axis Oe, which includes a light incident surface 511 and a light exiting surface 512. The incident optical axis Oi passes through and enters into the light incident surface 511. The exiting optical axis Oe passes through and is away from the light exiting surface 512. In the 1st Example of the 5th Embodiment, the light path folding element 510 is a prism.

The opaque body 520 includes a non-closed structure (its reference numeral is omitted) and a plurality of light blocking structures 522. The exiting optical axis Oe passes through a notch opening 521 of the non-closed ring structure. The light blocking structures 522 extend toward the exiting optical axis θe from the non-closed ring structure along a direction perpendicular to the exiting optical axis Oe, wherein the light blocking structures 522 are disposed adjacent to the light exiting surface 512 of the light path folding element 510.

Furthermore, the opaque body 520 and the light blocking structures 522 are formed integrally.

The light blocking structures 522 are the wavy shaped. Specifically, a part of the light blocking structures 522 forms a convex arc (its reference numeral is omitted), and a part of the light blocking structures 522 forms a concave arc (its reference numeral is omitted). The convex arc and the concave arc are arranged alternately.

Furthermore, in the 1st Example of the 5th Embodiment, the light path folding element 510 is made of plastic material. The opaque body 520 is made of black plastic material.

In FIG. 5E and FIG. 5F, according to the 1st Example of the 5th Embodiment, when the exiting optical axis Oe as a center of circle is taken, an angle occupied by the light blocking structures 522 is De, a number of the light blocking structures 522 is Ne, the convex arc has a curvature radius Re, the concave arc has a curvature radius Re′, a height of each of the light blocking structures 522 extending along the direction perpendicular to the exiting optical axis Oe is He, a length of each of the light blocking structures 522 extending along a direction parallel to the exiting optical axis Oe is Le, the following conditions shown in Table 5A are satisfied.

TABLE 5A
1st Example of 5th Embodiment

| | | | |
|---|---|---|---|
| θe (degrees) | 134.2 | He (mm) | 0.30 |
| Ne | 105 | Le (mm) | 0.92 |
| Re (mm) | 0.05 | Re′ (mm) | 0.05 |

### 6th Embodiment

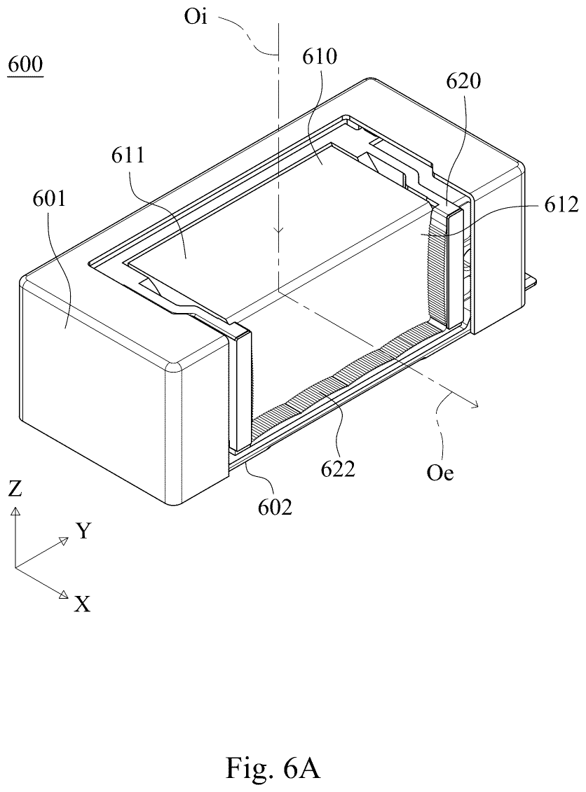

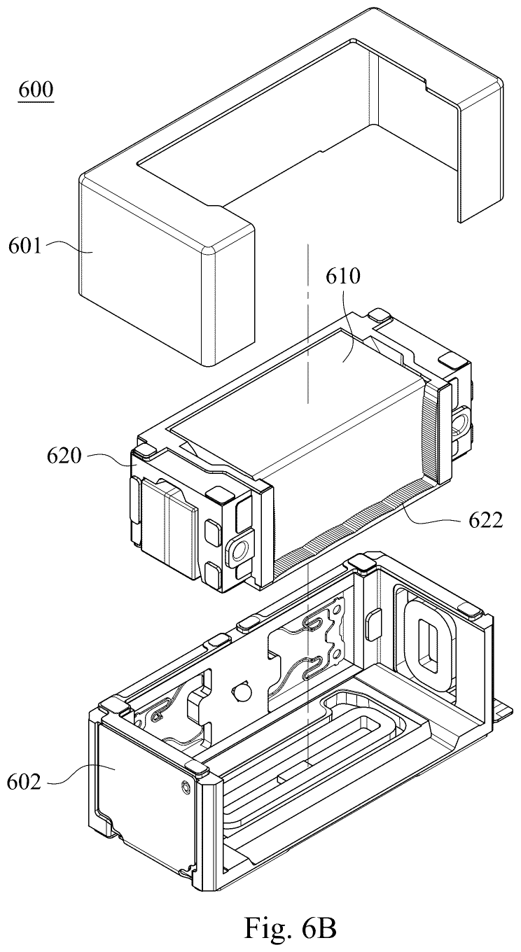

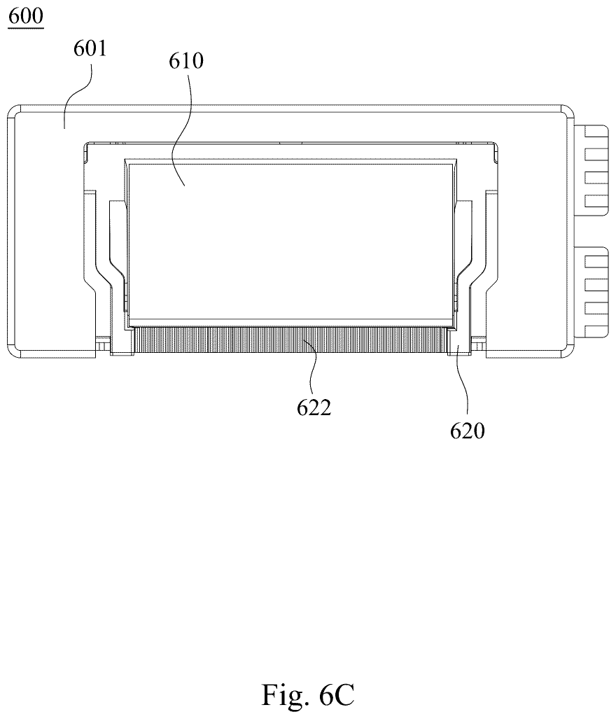

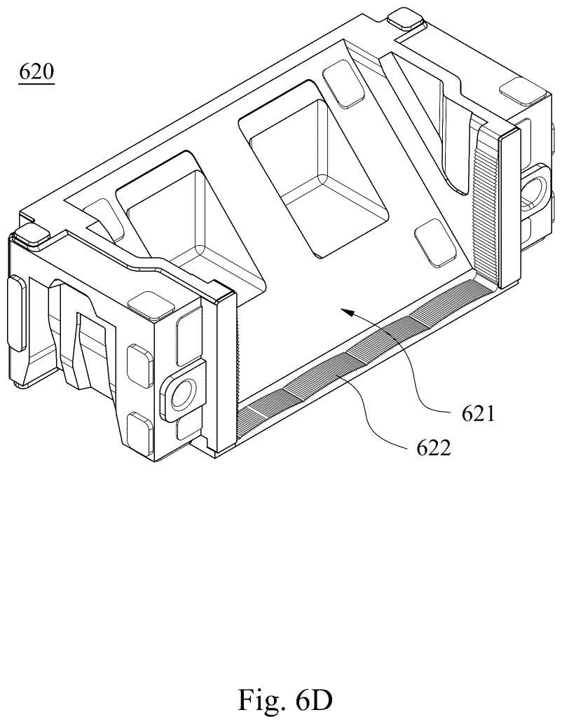

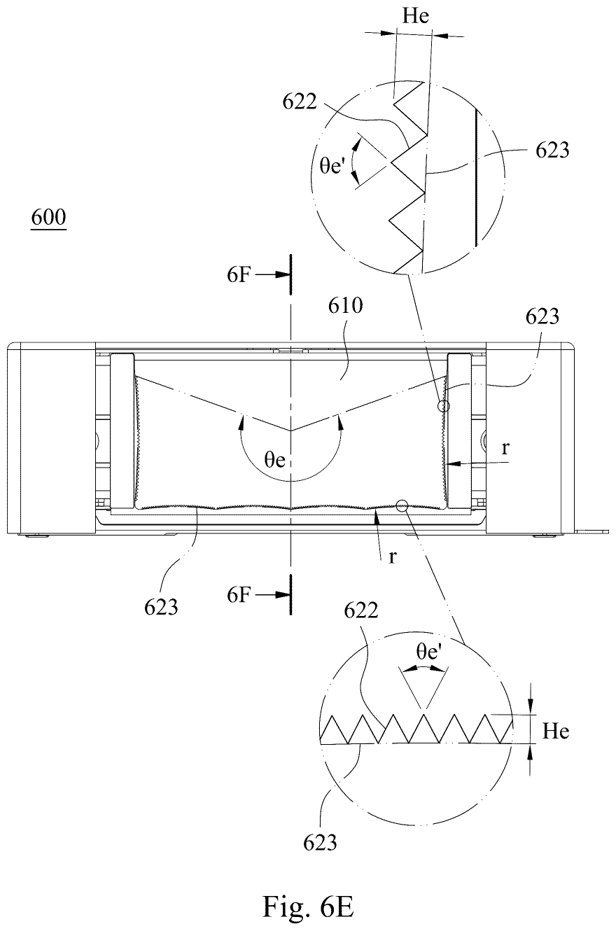

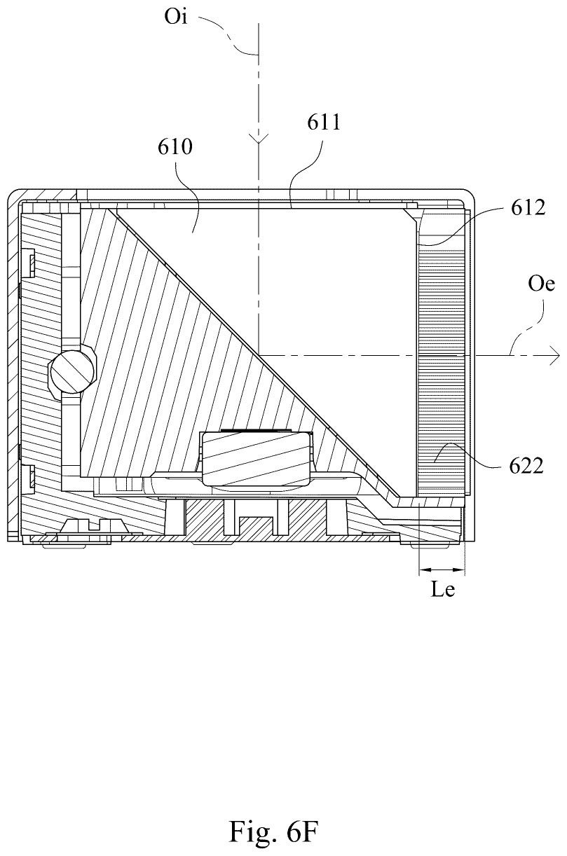

FIG. 6A is a schematic view of a light path folding module 600 of the 1st Example according to the 6th Embodiment of the present disclosure. FIG. 6B is an exploded view of the light path folding module 600 of the 1st Example according to the 6th Embodiment in FIG. 6A. FIG. 6C is a plane view of the light path folding module 600 of the 1st Example according to the 6th Embodiment in FIG. 6A. In FIG. 6A, FIG. 6B and FIG. 6C, the light path folding module 600 includes a light path folding element 610 and an opaque body 620, wherein the opaque body 620 is disposed relative to the light path folding element 610. Furthermore, the light path folding module 600 can further include a cover 601 and an assembly carrier 602, wherein the opaque body 620 and the light path folding element 610 are disposed on the assembly carrier 602. The cover 601 covers the assembly carrier 602, which is favorable for the overall light path folding module 600 disposing in the camera module or other devices.

FIG. 6D is a schematic view of the opaque body 620 of the 1st Example according to the 6th Embodiment in FIG. 6A. FIG. 6E is another plane view of the light path folding module 600 of the 1st Example according to the 6th Embodiment in FIG. 6A. FIG. 6F is a cross-sectional view along line 6F-6F in FIG. 6E. In FIG. 6D to FIG. 6F, the light path folding element 610 is for folding an incident optical axis Oi to an exiting optical axis Oe, which includes a light incident surface 611 and a light exiting surface 612. The incident optical axis Oi passes through and enters into the light incident surface 611. The exiting optical axis Oe passes through and is away from the light exiting surface 612. In the 1st Example of the 6th Embodiment, the light path folding element 610 is a prism.

The opaque body 620 includes a non-closed structure (its reference numeral is omitted) and a plurality of light blocking structures 622. The exiting optical axis Oe passes through a notch opening 621 of the non-closed ring structure. The light blocking structures 622 extend towards the exiting optical axis Oe from the non-closed ring structure along a direction perpendicular to the exiting optical axis Oe, wherein the light blocking structures 622 are disposed adjacent to the light exiting surface 612 of the light path folding element 610. Furthermore, the opaque body 620 and the light blocking structures 622 are formed integrally.

Each of the light blocking structures 622 extends toward the exiting optical axis Oe and gradually shrinks and intersects. Each of the light blocking structures 622 is a wedge-shaped protrusion. Specifically, the light blocking structures 622 are arranged on the non-closed ring structure substantially along a circumferential direction surrounding the exiting optical axis Oe. Furthermore, the light blocking structures 622 are generally arranged in a U-shaped distribution with the exiting optical axis Oe as a center. In the U-shaped distribution, the shape and the size of the light blocking structures 622 located at the bottom of the U-shaped and the light blocking structures 622 located at the both sides of the U-shaped are slightly different (the differences are shown in Table 6A as follows).

Furthermore, the non-closed ring structure can further include a plurality of auxiliary arcs 623, and the light blocking structures 622 are disposed on the auxiliary arcs 623. Specifically, the shape and the size of the auxiliary arcs 623 located at the bottom of the U-shaped and the auxiliary arcs 623 located at the both sides of the U-shaped are slightly different (the differences are shown in Table 6A as follows).

Furthermore, in the 1st Example of the 6th Embodiment, the light path folding element 610 is made of plastic material. The opaque body 620 is made of black plastic material.

In FIG. 6E and FIG. 6F, according to the 1st Example of the 6th Embodiment, when the exiting optical axis Oe as a center of circle is taken, an angle occupied by the light blocking structures 622 is ee, a number of the light blocking structures 622 is Ne, the wedge-shaped protrusion has an included angle θe′, the auxiliary arcs 623 has a curvature radius r, a height of each of the light blocking structures 622 extending along the direction perpendicular to the exiting optical axis Oe is He, a length of each of the light blocking structures 622 extending along a direction parallel to the exiting optical axis Oe is Le, the following conditions shown in Table 6A are satisfied. It must be noted that, as shown in Table 6A, in the columns of θe′, r and He, the value on the left side is the value of the light blocking structures 622 and the auxiliary arcs 623 located at the bottom of the U-shaped, and the value on the right side is the value of the light blocking structures 622 and the auxiliary arcs 623 located at the both sides of the U-shaped.

TABLE 6A
1st Example of 6th Embodiment

| | | | |
|---|---|---|---|
| θe (degrees) | 219.2 | He (mm) | 0.06, 0.07 |
| Ne | 232 | Le (mm) | 0.87 |
| θe′ (degrees) | 55.6, 78.8 | r (mm) | 9.0, 27.4 |

### 7th Embodiment

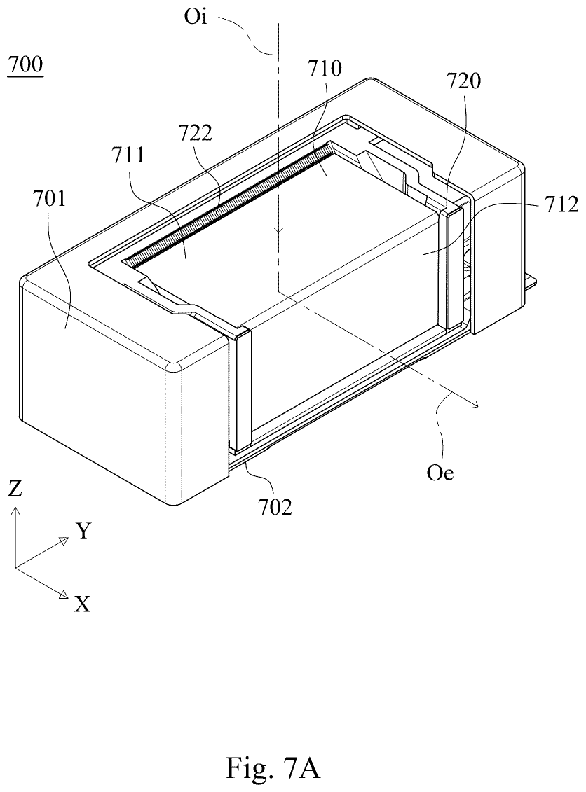

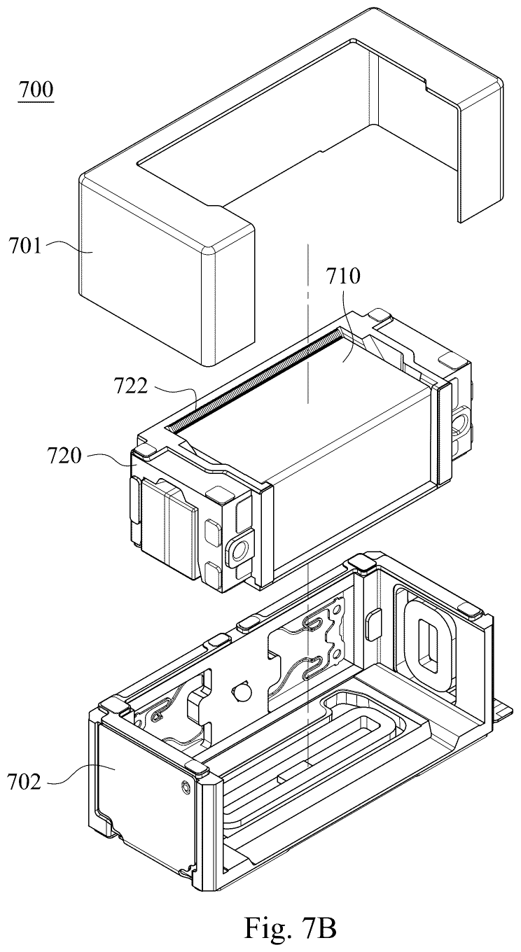

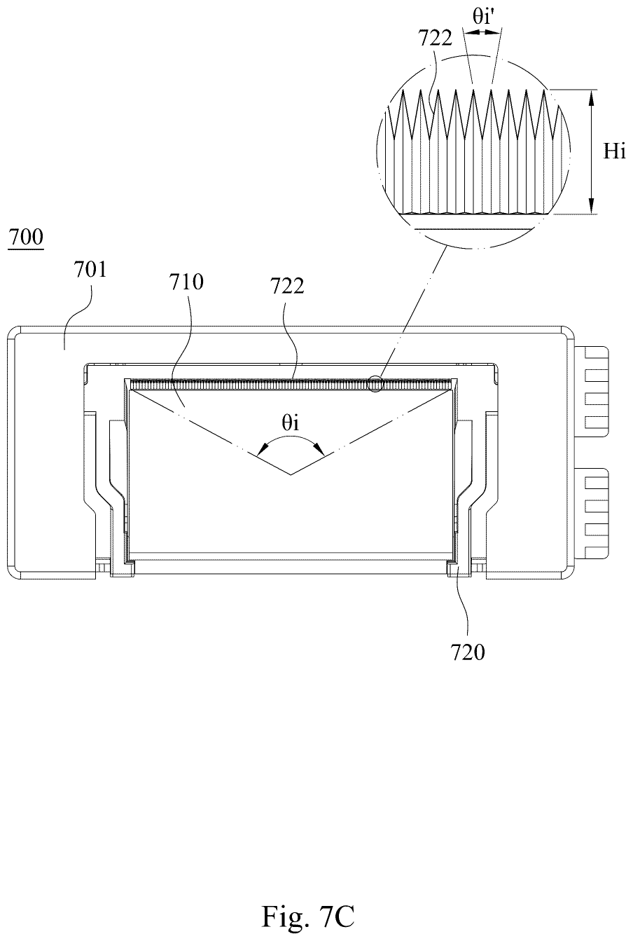

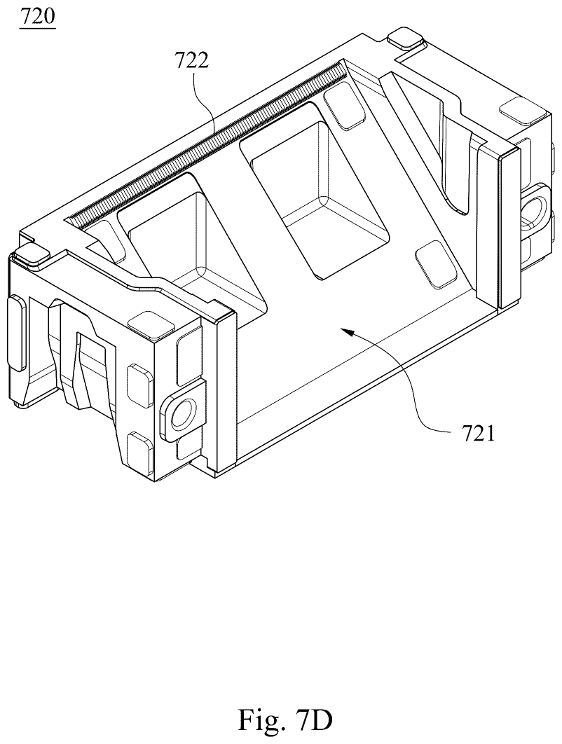

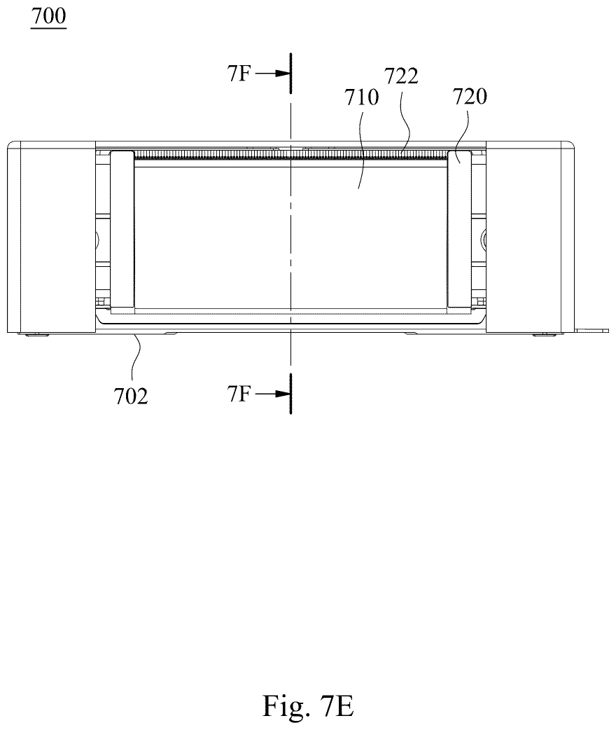

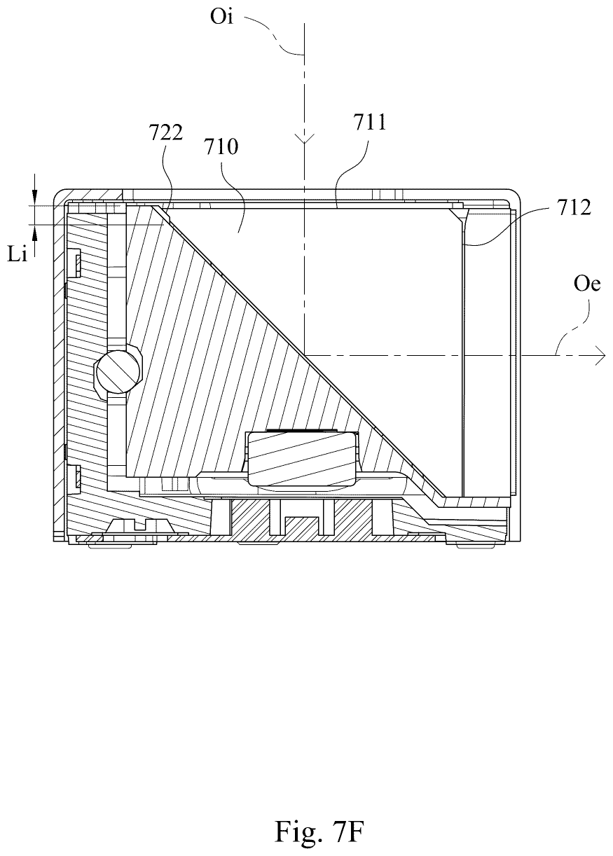

FIG. 7A is a schematic view of a light path folding module 700 of the 1st Example according to the 7th Embodiment of the present disclosure. FIG. 7B is an exploded view of the light path folding module 700 of the 1st Example according to the 7th Embodiment in FIG. 7A. FIG. 7C is a plane view of the light path folding module 700 of the 1st Example according to the 7th Embodiment in FIG. 7A. In FIG. 7A, FIG. 7B and FIG. 7C, the light path folding module 700 includes a light path folding element 710 and an opaque body 720, wherein the opaque body 720 is disposed relative to the light path folding element 710. Furthermore, the light path folding module 700 can further include a cover 701 and an assembly carrier 702, wherein the opaque body 720 and the light path folding element 710 are disposed on the assembly carrier 702. The cover 701 covers the assembly carrier 702, which is favorable for the overall light path folding module 700 disposing in the camera module or other devices.

FIG. 7D is a schematic view of the opaque body 720 of the 1st Example according to the 7th Embodiment in FIG. 7A. FIG. 7E is another plane view of the light path folding module 700 of the 1st Example according to the 7th Embodiment in FIG. 7A. FIG. 7F is a cross-sectional view along line 7F-7F in FIG. 7E. In FIG. 7D to FIG. 7F, the light path folding element 710 is for folding an incident optical axis Oi to an exiting optical axis Oe, which includes a light incident surface 711 and a light exiting surface 712. The incident optical axis Oi passes through and enters into the light incident surface 711. The exiting optical axis Oe passes through and is away from the light exiting surface 712. In the 1st Example of the 7th Embodiment, the light path folding element 710 is a prism.

The opaque body 720 includes a non-closed structure (its reference numeral is omitted) and a plurality of light blocking structures 722. The incident optical axis Oi passes through a notch opening 721 of the non-closed ring structure. The light blocking structures 722 extend towards the incident optical axis Oi from the non-closed ring structure along a direction perpendicular to the incident optical axis Oi, wherein the light blocking structures 722 are disposed adjacent to the light incident surface 711 of the light path folding element 710. Furthermore, the opaque body 720 and the light blocking structures 722 are formed integrally.

Each of the light blocking structures 722 extends toward the incident optical axis Oi and gradually shrinks and intersects. Each of the light blocking structures 722 is a wedge-shaped protrusion.

Furthermore, in the 1st Example of the 7th Embodiment, the light path folding element 710 is made of plastic material. The opaque body 720 is made of black plastic material.

In FIG. 7C and FIG. 7F, according to the 1st Example of the 7th Embodiment, when the incident optical axis Oi as a center of circle is taken, an angle occupied by the light blocking structures 722 is θi, a number of the light blocking structures 722 is Ni, the wedge-shaped protrusion has an included angle θi′, a height of each of the light blocking structures 722 extending along the direction perpendicular to the incident optical axis Oi is Hi, a length of each of the light blocking structures 722 extending along a direction parallel to the incident optical axis Oi is Li, the following conditions shown in Table 7A are satisfied.

TABLE 7A
1st Example of 7th Embodiment

| | | | |
|---|---|---|---|
| θi (degrees) | 123.6 | Hi (mm) | 0.35 |
| Ni | 220 | Li (mm) | 0.35 |
| θi′ (degrees) | 20 | | |

### 8th Embodiment

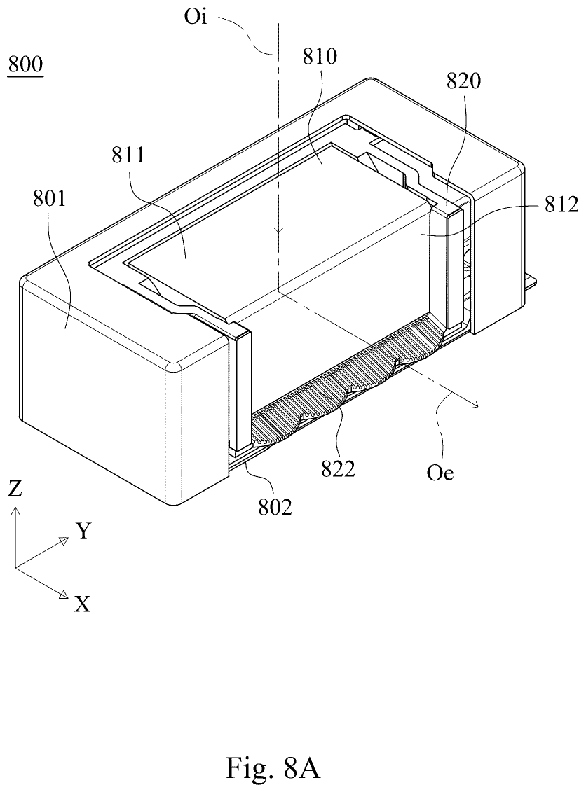

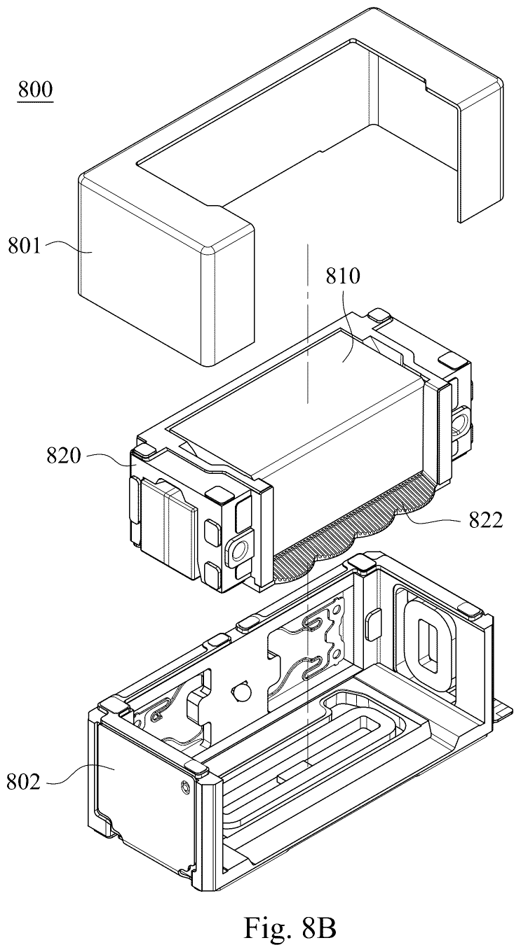

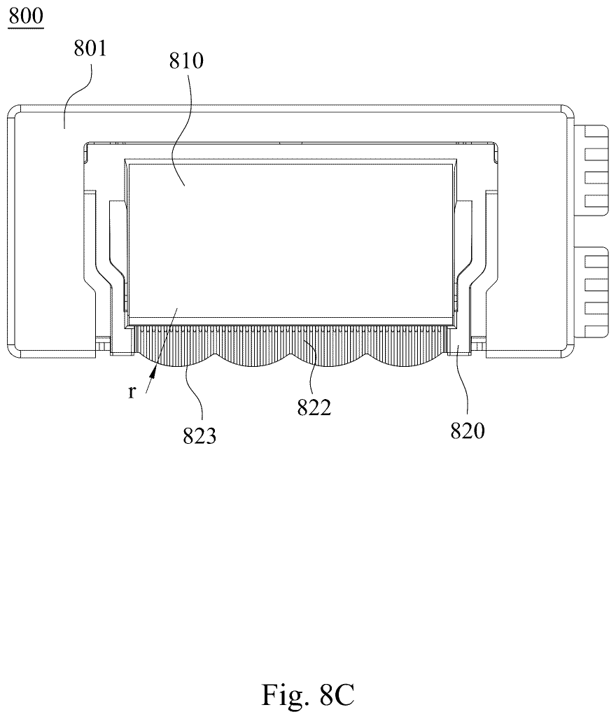

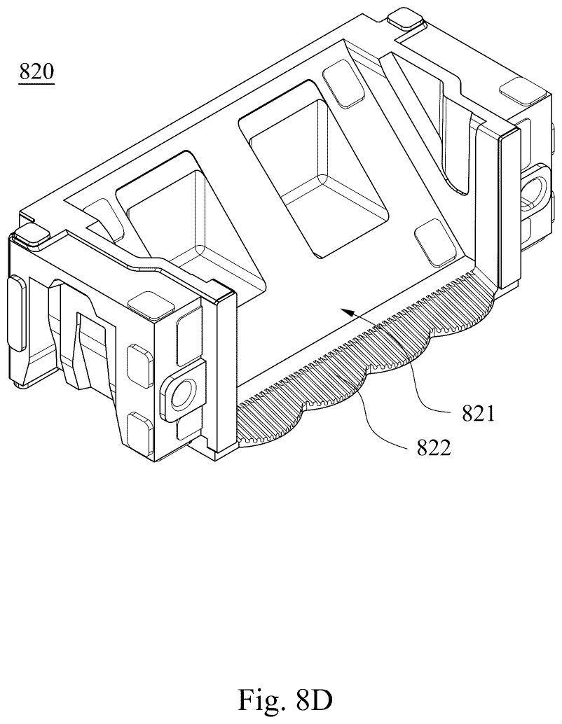

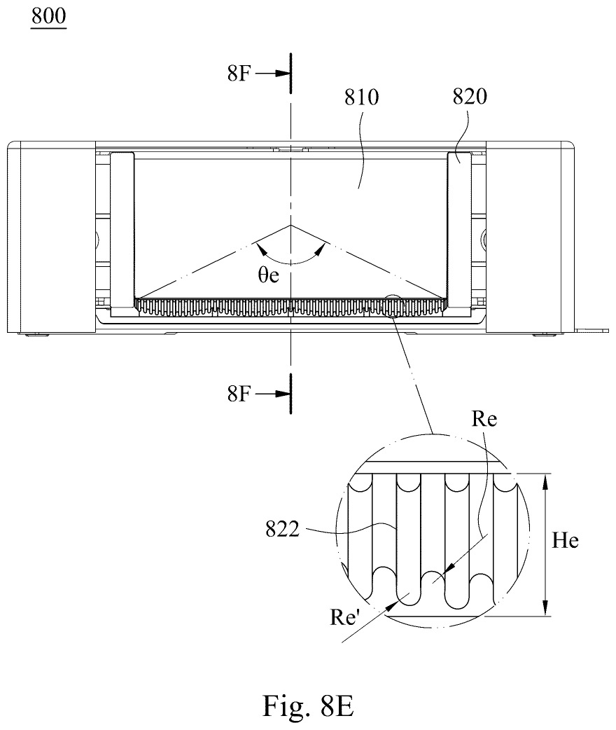

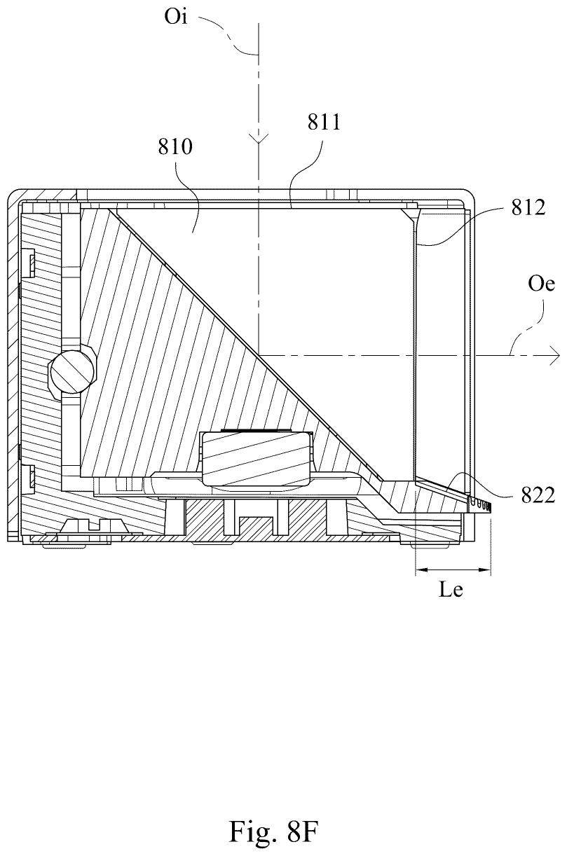

FIG. 8A is a schematic view of a light path folding module 800 of the 1st Example according to the 8th Embodiment of the present disclosure. FIG. 8B is an exploded view of the light path folding module 800 of the 1st Example according to the 8th Embodiment in FIG. 8A. FIG. 8C is a plane view of the light path folding module 800 of the 1st Example according to the 8th Embodiment in FIG. 8A. In FIG. 8A, FIG. 8B and FIG. 8C, the light path folding module 800 includes a light path folding element 810 and an opaque body 820, wherein the opaque body 820 is disposed relative to the light path folding element 810. Furthermore, the light path folding module 800 can further include a cover 801 and an assembly carrier 802, wherein the opaque body 820 and the light path folding element 810 are disposed on the assembly carrier 802. The cover 801 covers the assembly carrier 802, which is favorable for the overall light path folding module 800 disposing in the camera module or other devices.

FIG. 8D is a schematic view of the opaque body 820 of the 1st Example according to the 8th Embodiment in FIG. 8A. FIG. 8E is another plane view of the light path folding module 800 of the 1st Example according to the 8th Embodiment in FIG. 8A. FIG. 8F is a cross-sectional view along line 8F-8F in FIG. 8E. In FIG. 8D to FIG. 8F, the light path folding element 810 is for folding an incident optical axis Oi to an exiting optical axis Oe, which includes a light incident surface 811 and a light exiting surface 812. The incident optical axis Oi passes through and enters into the light incident surface 811. The exiting optical axis Oe passes through and is away from the light exiting surface 812. In the 1st Example of the 8th Embodiment, the light path folding element 810 is a prism.

The opaque body 820 includes a non-closed structure (its reference numeral is omitted) and a plurality of light blocking structures 822. The exiting optical axis Oe passes through a notch opening 821 of the non-closed ring structure. The light blocking structures 822 extend towards the exiting optical axis Oe from the non-closed ring structure along a direction perpendicular to the exiting optical axis Oe, wherein the light blocking structures 822 are disposed adjacent to the light exiting surface 812 of the light path folding element 810. Furthermore, the opaque body 820 and the light blocking structures 822 are formed integrally.

The light blocking structures 822 are wavy-shaped. Specifically, a part of the light blocking structures 822 forms a convex arc (its reference numeral is omitted), and a part of the light blocking structures 822 forms a concave arc (its reference numeral is omitted). The convex arc and the concave arc are arranged alternately. Furthermore, the non-closed ring structure can further include a plurality of auxiliary arcs 823, and the light blocking structures 822 are disposed on the auxiliary arcs 823.

Furthermore, in the 1st Example of the 8th Embodiment, the light path folding element 810 is made of plastic material. The opaque body 820 is made of black plastic material.

In FIG. 8C, FIG. 8E and FIG. 8F, according to the 1st Example of the 8th Embodiment, when the exiting optical axis Oe as a center of circle is taken, an angle occupied by the light blocking structures 822 is θe, a number of the light blocking structures 822 is Ne, the convex arc has a curvature radius Re, the concave arc has a curvature radius Re′, the auxiliary arcs 823 has a curvature radius r, a height of each of the light blocking structures 822 extending along the direction perpendicular to the exiting optical axis Oe is He, a length of each of the light blocking structures 822 extending along a direction parallel to the exiting optical axis Oe is Le, the following conditions shown in Table 8A are satisfied.

TABLE 8A
1st Example of 8th Embodiment

| | | | |
|---|---|---|---|
| θe (degrees) | 130.6 | He (mm) | 0.59 |
| Ne | 105 | Le (mm) | 1.40 |
| Re (mm) | 0.05 | Re′ (mm) | 0.05 |
| r (mm) | 2 | | |

### 9th Embodiment

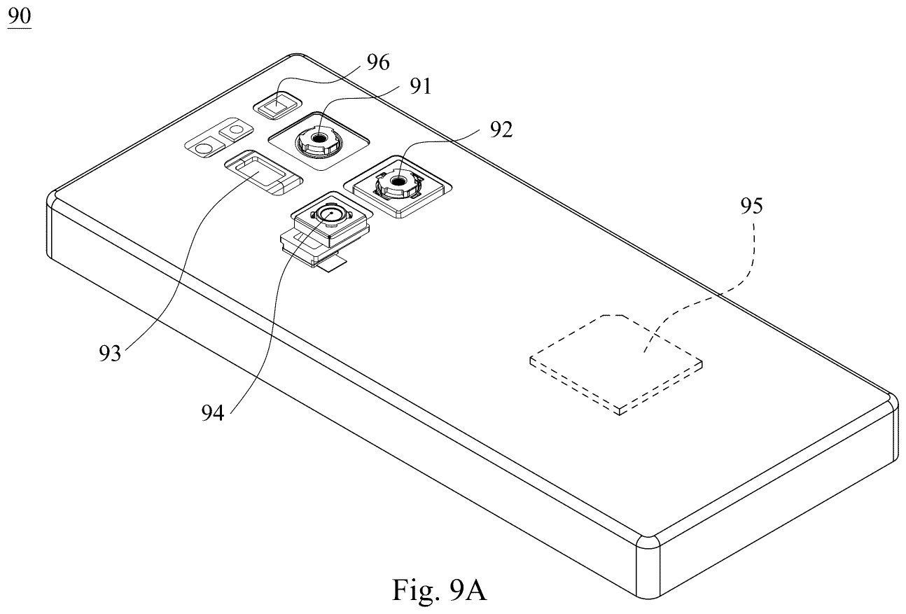

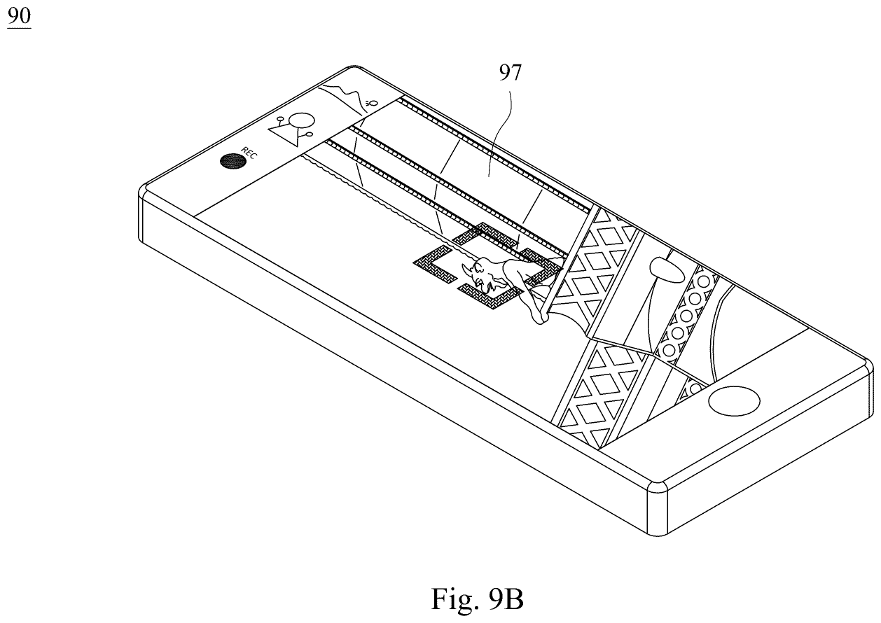

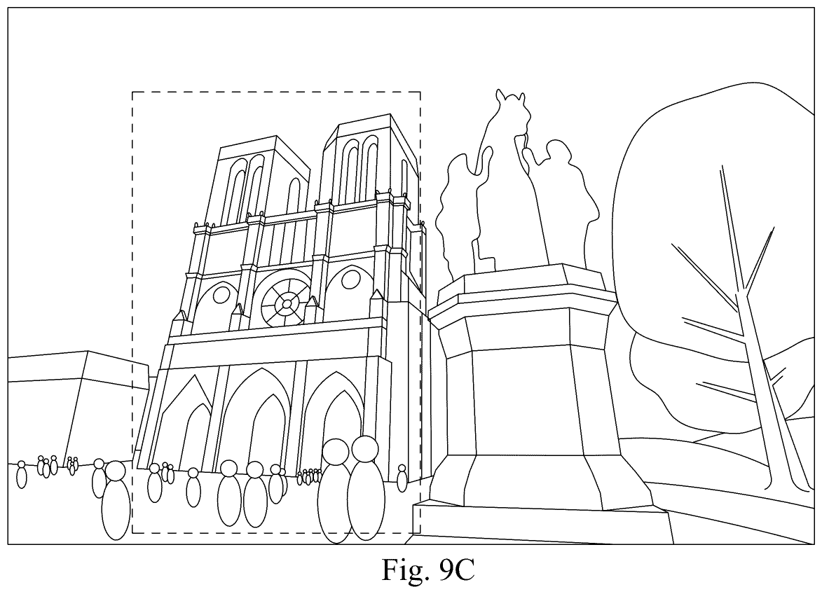

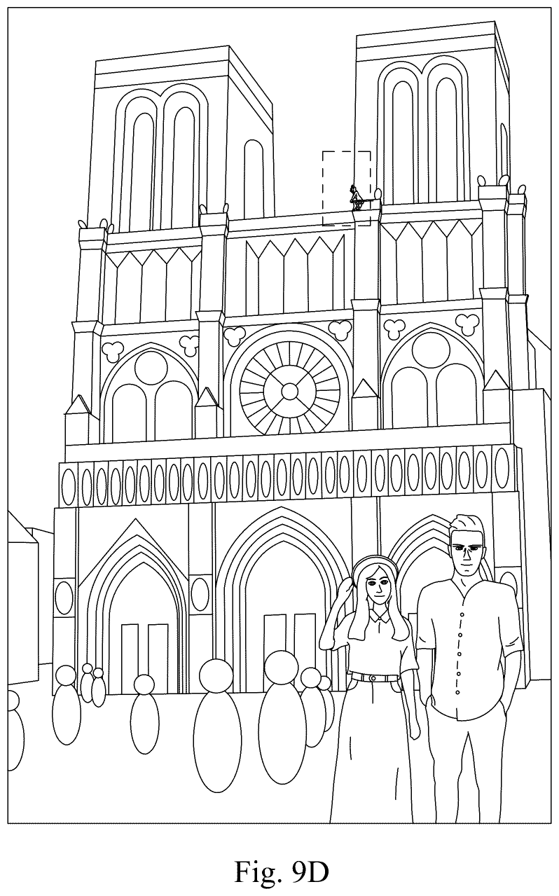

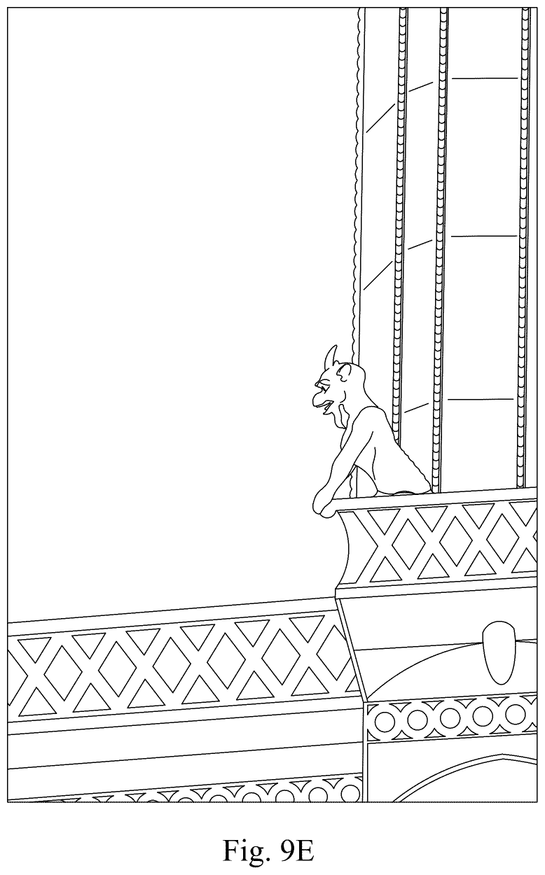

FIG. 9A is a schematic view of an electronic device 90 according to the 9th Embodiment of the present disclosure. FIG. 9B is another schematic view of the electronic device 90 according to the 9th Embodiment in FIG. 9A. In FIG. 9A and FIG. 9B, the electronic device 90 is a smart phone, and includes a plurality of camera modules, a plurality of image sensors and a user interface 97, wherein the image sensors are disposed on an imaging surface of each camera module, respectively. Furthermore, the camera module includes a high-pixel camera module 91, an ultra-wide angle camera module 92 and two telephoto camera modules 93, 94, and the user interface 97 is a touch screen, which is not limited thereto. Specifically, each camera module can include the light path folding module according to any one example of the aforementioned 1st Embodiment to 8th Embodiment and an imaging lens assembly, and the imaging lens assembly is disposed adjacent to the light path folding module, but the present disclosure is not limited thereto.

Furthermore, users enter a shooting mode via the user interface 97, wherein the user interface 97 is for displaying the scene, and the shooting angle can be manually adjusted to switch the different camera modules. At this moment, the imaging light is gathered on the image sensor via the camera module, and an electronic signal about an image is output to an image signal processor (ISP) 95.

In FIG. 9A, to meet a specification of the electronic device 90, the electronic device 90 can further include an optical anti-shake mechanism (not shown in drawings). Furthermore, the electronic device 90 can further include at least one focusing assisting module (not shown in drawings) and at least one sensing element (not shown in drawings). The focusing assisting module can be a flash module 96 for compensating a color temperature, an infrared distance measurement component, a laser focus module, etc. The sensing element can have functions for sensing physical momentum and kinetic energy, such as an accelerator, a gyroscope, a Hall Effect Element, to sense shaking or jitters applied by hands of the user or external environments. Accordingly, the camera module of the electronic device 90 equipped with an auto-focusing mechanism and the optical anti-shake mechanism can be enhanced to achieve the superior image quality. Furthermore, the electronic device 90 according to the present disclosure can have a capturing function with multiple modes, such as taking optimized selfies, high dynamic range (HDR) under a low light condition, 4K resolution recording, etc. Furthermore, the users can visually see a captured image of the camera through the user interface 97 and manually operate the view finding range on the user interface 97 to achieve the auto-focus function of what you see is what you get.

Moreover, the camera module, the optical anti-shake mechanism, the sensing element and the focusing assisting module can be disposed on a flexible printed circuit board (FPC) (not shown in drawings) and electrically connected to the associated components, such as the image signal processor 95, via a connector (not shown in drawings) to perform a capturing process. Since the current electronic devices, such as smart phones, have a tendency of being compact, the way of firstly disposing the camera module and related components on the flexible printed circuit board and secondly integrating the circuit thereof into the main board of the electronic device via the connector can satisfy the requirements of the mechanical design and the circuit layout of the limited space inside the electronic device, and obtain more margins. The autofocus function of the camera module can also be controlled more flexibly via the touch screen of the electronic device. According to the 9th Embodiment, the electronic device 90 can include a plurality of sensing elements and a plurality of focusing assisting modules. The sensing elements and the focusing assisting modules are disposed on the flexible printed circuit board and at least one other flexible printed circuit board (not shown in drawings) and electrically connected to the associated components, such as the image signal processor 95, via corresponding connectors to perform the capturing process. In other examples (not shown in drawings), the sensing elements and the focusing assisting modules can also be disposed on the main board of the electronic device or carrier boards of other types according to requirements of the mechanical design and the circuit layout.

Furthermore, the electronic device 90 can further include, but not be limited to, a display, a control unit, a storage unit, a random access memory (RAM), a read-only memory (ROM), or the combination thereof.

FIG. 9C is a schematic view of an image captured by the electronic device 90 according to the 9th Embodiment in FIG. 9A. In FIG. 9C, the larger range of the image can be captured via the ultra-wide angle camera module 92, and the ultra-wide angle camera module 92 can have the function of accommodating more wide range of the scene.

FIG. 9D is another schematic view of an image captured by the electronic device 90 according to the 9th Embodiment in FIG. 9A. In FIG. 9D, the image of the certain range with the high resolution can be captured via the high resolution camera module 91, and the high resolution camera module 91 has the function of the high resolution and the low deformation.

FIG. 9E is further another schematic view of an image captured by the electronic device 90 according to the 9th Embodiment in FIG. 9A. In FIG. 9E, the telephoto camera modules 93, 94 have the enlarging function of the high magnification, and the distant image can be captured and enlarged with high magnification via the telephoto camera modules 93, 94.

In FIG. 9C to FIG. 9E, the zooming function can be obtained via the electronic device 90, when the scene is captured via the camera module with different focal lengths cooperated with the function of image processing.

### 10th Embodiment

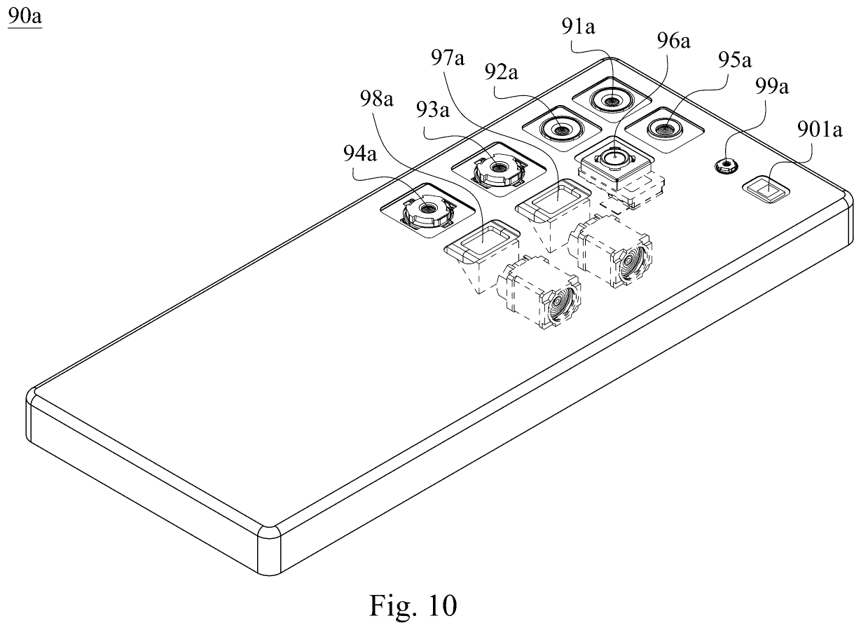

FIG. 10 is a schematic view of an electronic device 90a according to the 10th Embodiment of the present disclosure. In FIG. 10, the electronic device 90a is a smart phone, and includes a plurality of camera modules and a plurality of image sensors, wherein the image sensors are disposed on an imaging surface of each camera module, respectively. Furthermore, the camera module includes the ultra-wide angle camera modules 91a, 92a, the wide angle camera modules 93a, 94a, the telephoto camera modules 95a, 96a, 97a, 98a, and a Time-Of-Flight (TOF) module 99a. The TOF module 99a can be another type of the camera module, and the disposition is not limited thereto. In detail, the camera modules can include the light path folding module according to any one example of the aforementioned 1st Embodiment to 8th Embodiment and an imaging lens assembly, and the imaging lens assembly is disposed adjacent to the light path folding module, but the present disclosure is not limited thereto.

Further, the telephoto camera modules 97a, 98a are configured to fold the light path, but the present disclosure is not limited thereto.

To meet a specification of the electronic device 90a, the electronic device 90a can further include an optical anti-shake mechanism (not shown in drawings). Furthermore, the electronic device 90a can further include at least one focusing assisting module (not shown in drawings) and at least one sensing element (not shown in drawings). The focusing assisting module can be a flash module 901a for compensating a color temperature, an infrared distance measurement component, a laser focus module, etc. The sensing element can have functions for sensing physical momentum and kinetic energy, such as an accelerator, a gyroscope, a Hall Effect Element, to sense shaking or jitters applied by hands of the user or external environments. Accordingly, the camera module of the electronic device 90a equipped with an auto-focusing mechanism and the optical anti-shake mechanism can be enhanced to achieve the superior image quality. Furthermore, the electronic device 90a according to the present disclosure can have a capturing function with multiple modes, such as taking optimized selfies, High Dynamic Range (HDR) under a low light condition, 4K Resolution recording, etc.

Further, all of other structures and dispositions according to the 10th Embodiment are the same as the structures and the dispositions according to the 9th Embodiment, and will not be described again herein.

### 11th Embodiment

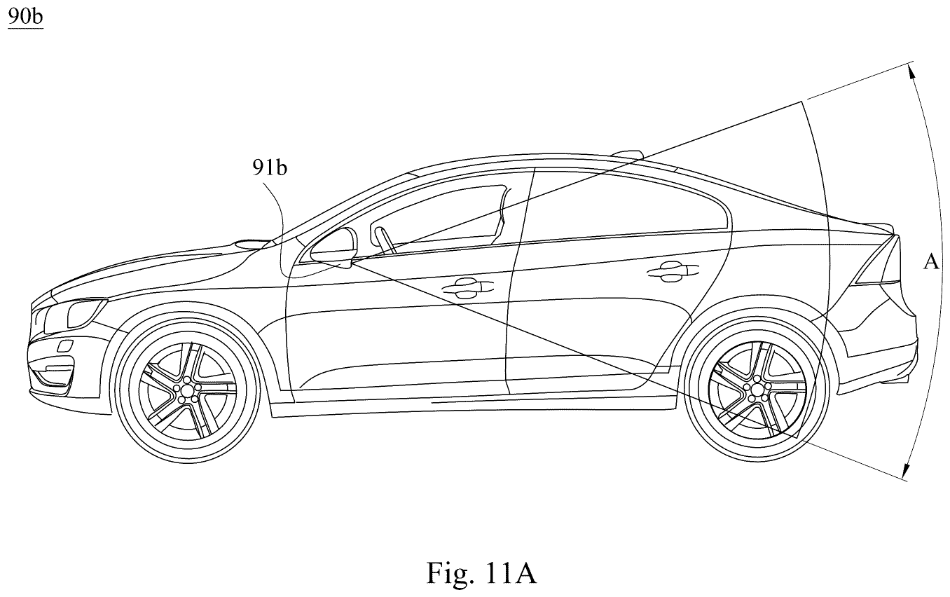

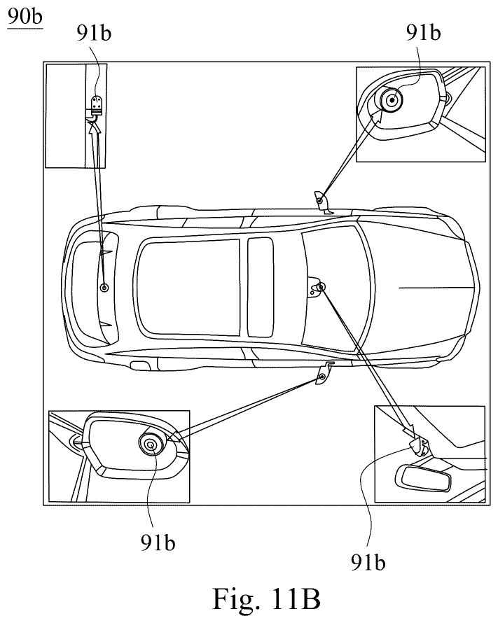

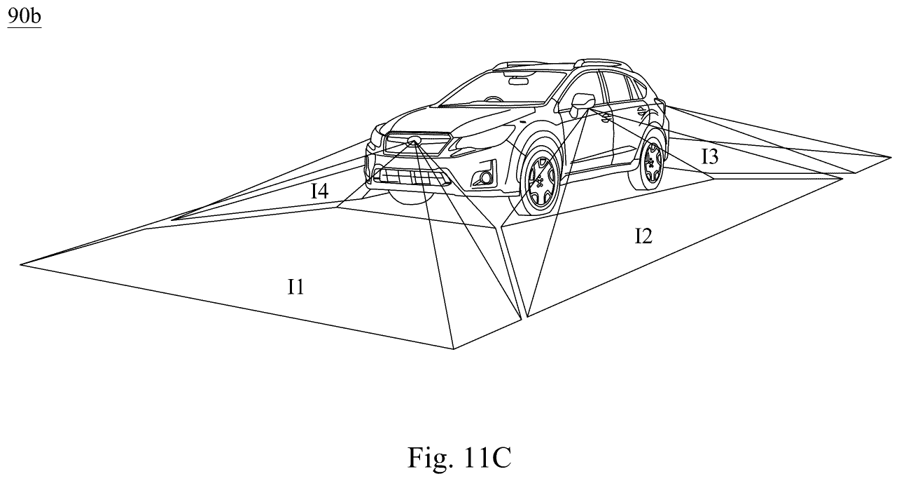

FIG. 11A is a schematic view of a vehicle device 90b according to the 11th Embodiment of the present disclosure. FIG. 11B is another schematic view of the vehicle device 90b according to the 11th Embodiment in FIG. 11A. FIG. 11C is further another schematic view of the vehicle device 90b according to the 11th Embodiment in FIG. 11A. In FIG. 11A to FIG. 11C, the vehicle device 90b includes a plurality of camera modules 91b and a plurality of image sensors, wherein the image sensors are disposed on an imaging surface of each camera module 91b, respectively. In the 11th Embodiment, a number of the camera modules 91b is six, and the camera modules 91b can include the light path folding module according to any one example of the aforementioned 1st Embodiment to 8th Embodiment and an imaging lens assembly, and the imaging lens assembly is disposed adjacent to the light path folding module, but the present disclosure is not limited thereto.

In FIG. 11A to FIG. 11B, the camera module 91b is a vehicle camera module, and two of the camera modules 91b are located under two rear view mirrors on the left side and the right side, respectively. Each of the two camera modules 91b captures image information from a field of view A. Specifically, the field of view A can satisfy the following condition: 40 degrees<A<90 degrees. Hence, the image information in the region of two lanes on the left side and the right side can be captured.

In FIG. 11B, another two of the camera modules 91b can be disposed in an inner space of the vehicle device 90b. Specifically, the aforementioned two camera modules 91b can be disposed near a rear view mirror in the vehicle device 90b and near a rear window, respectively, or can be disposed on non-mirror surfaces of two rear view mirrors on left side and right side of the vehicle device 90b, respectively, but not limited thereto.

In FIG. 11C, further another two of the camera modules 91b can be disposed at the front end and the rear end of the vehicle device 90b. Furthermore, the traffic information outside the vehicle can be identified helpfully by the arrangement of the camera modules 91b disposed at the front end, the rear end and below the left and right rear view mirrors of the vehicle device 90b. The traffic information outside the vehicle can be 11, 12, 13, 14, but not limited thereto. Therefore, the angle of view can be provided widely to decrease the blind spot, which is favorable for improving driving safety. Furthermore, it is favorable for identifying the external space information out of the vehicle device 90b by arranging the camera modules 91b around the vehicle device 90b to achieve the function of autopilot.

The foregoing description, for purpose of explanation, has been described with reference to specific embodiments. The embodiments were chosen and described in order to best explain the principles of the disclosure and its practical applications, to thereby enable others skilled in the art to best utilize the disclosure and various embodiments with various modifications as are suited to the particular use contemplated. The embodiments depicted above and the appended drawings are exemplary and are not intended to be exhaustive or to limit the scope of the present disclosure to the precise forms disclosed. Many modifications and variations are possible in view of the above teachings.

What is claimed is:

1. A light path folding module, comprising:
a light path folding element for folding an incident optical axis to an exiting optical axis, and the light path folding element comprising:
a light incident surface, wherein the incident optical axis passes through and enters into the light incident surface; and
a light exiting surface, wherein the exiting optical axis passes through and is away from the light exiting surface; and
an opaque body disposed relative to the light path folding element, and the opaque body comprising:
a non-closed ring structure, wherein the exiting optical axis passes through a notch opening of the non-closed ring structure; and
a plurality of light blocking structures extending towards the exiting optical axis from the non-closed ring structure along a direction perpendicular to the exiting optical axis, wherein the plurality of light blocking structures are disposed adjacent to the light exiting surface of the light path folding element;
wherein when the exiting optical axis as a center of circle is taken, an angle occupied by the plurality of light blocking structures is θe, a number of the plurality of light blocking structures is Ne, and the following conditions are satisfied:
$$10 degrees < θ e < 350 degrees ;$$
$$a nd$$
$$15 < Ne < 460.$$

2. The light path folding module of claim 1, wherein each of the plurality of light blocking structures extends towards the exiting optical axis and gradually shrinks and intersects.

3. The light path folding module of claim 1, wherein the opaque body and the plurality of light blocking structures are formed integrally.

4. The light path folding module of claim 1, wherein when the exiting optical axis as the center of circle is taken, the angle occupied by the plurality of light blocking structures is θe, the number of the plurality of light blocking structures is Ne, and the following conditions are satisfied:
$$10 degrees < θ e < 150 degrees ;$$
$$and$$
$$15 < Ne < 250.$$

5. The light path folding module of claim 1, wherein when the exiting optical axis as the center of circle is taken, the angle occupied by the plurality of light blocking structures is θe, the number of the plurality of light blocking structures is Ne, and the following conditions are satisfied:
$$110 degrees < θ e < 350 degrees ;$$
$$and$$
$$50 < Ne < 30 0.$$

6. The light path folding module of claim 1, wherein each of the plurality of light blocking structures is a wedge-shaped protrusion, the wedge-shaped protrusion has an included angle θe′, and the following condition is satisfied:
$$0 degrees < θ {e}^{′} < 90 degrees .$$

7. The light path folding module of claim 1, wherein each of the plurality of light blocking structures forms a convex arc, the convex arc has a curvature radius Re, and the following condition is satisfied:
$$0 mm < Re < 0.3 mm .$$

8. The light path folding module of claim 1, wherein each of the plurality of light blocking structures forms a concave arc, the concave arc has a curvature radius Re′, and the following condition is satisfied:
$$0 mm < {Re}^{′} < 0.3 mm .$$

9. The light path folding module of claim 1, wherein the non-closed ring structure further comprises at least one auxiliary arc, at least one portion of the plurality of light blocking structures is disposed on the at least one auxiliary arc, the at least one auxiliary arc has a curvature radius r, and the following condition is satisfied:
$$0.5 mm < r < 50 mm .$$

10. The light path folding module of claim 1, wherein a height of each of the plurality of light blocking structures extends along the direction perpendicular to the exiting optical axis is He, and the following condition is satisfied:
$$0.1 mm < He < 1.2 mm .$$

11. The light path folding module of claim 1, wherein a length of each of the plurality of light blocking structures extending along a direction parallel to the exiting optical axis is Le, and the following condition is satisfied:
$$0.01 mm < L e < 2.8 mm .$$

12. The light path folding module of claim 1, wherein the light path folding element is made of plastic material.

13. The light path folding module of claim 1, wherein the opaque body is made of black plastic material.

14. A camera module, comprising:
the light path folding module of claim 1; and
an imaging lens assembly disposed adjacent to the light path folding module.

15. An electronic device, comprising:
the camera module of claim 14; and
an image sensor disposed on an imaging surface of the camera module.

16. A light path folding module, comprising:
a light path folding element for folding an incident optical axis to an exiting optical axis, and the light path folding element comprising:
a light incident surface, wherein the incident optical axis passes through and enters into the light incident surface; and
a light exiting surface, wherein the exiting optical axis passes through and is away from the light exiting surface; and
an opaque body disposed relative to the light path folding element, and the opaque body comprising:
a non-closed ring structure, wherein the incident optical axis passes through a notch opening of the non-closed ring structure; and
a plurality of light blocking structures extending towards the incident optical axis from the non-closed ring structure along a direction perpendicular to the incident optical axis, wherein the plurality of light blocking structures are disposed adjacent to the light incident surface of the light path folding element;
wherein when the incident optical axis as a center of circle is taken, an angle occupied by the plurality of light blocking structures is θi, a number of the plurality of light blocking structures is Ni, and the following conditions are satisfied:
$$10 degrees < θ i < 350 degrees ;$$
$$and$$
$$15 < Ni < 460.$$

17. The light path folding module of claim 16, wherein each of the plurality of light blocking structures extends towards the incident optical axis and gradually shrinks and intersects.

18. The light path folding module of claim 16, wherein the opaque body and the plurality of light blocking structures are formed integrally.

19. The light path folding module of claim 16, wherein when the incident optical axis as the center of circle is taken, the angle occupied by the plurality of light blocking structures is θi, the number of the plurality of light blocking structures is Ni, and the following conditions are satisfied:
$$10 degrees < θ i < 150 degrees ;$$
$$and$$
$$15 < Ni < 250.$$

20. The light path folding module of claim 16, wherein when the incident optical axis as the center of circle is taken, the angle occupied by the plurality of light blocking structures is θi, the number of the plurality of light blocking structures is Ni, and the following conditions are satisfied:
$$10 degrees < θ i < 350 degrees ;$$
$$and$$
$$50 < Ni < 300.$$

21. The light path folding module of claim 16, wherein each of the plurality of light blocking structures is a wedge-shaped protrusion, the wedge-shaped protrusion has an included angle θi′, and the following condition is satisfied:
$$0 degrees < θ {i}^{′} < 90 degrees .$$

22. The light path folding module of claim 16, wherein each of the plurality of light blocking structures forms a convex arc, the convex arc has a curvature radius Ri, and the following condition is satisfied:
$$0 mm < R i < 0.3 mm .$$

23. The light path folding module of claim 16, wherein each of the plurality of light blocking structures forms a concave arc, the concave arc has a curvature radius Ri′, and the following condition is satisfied:
$$0 mm < {Ri}^{′} < 0.3 mm .$$

24. The light path folding module of claim 16, wherein the non-closed ring structure further comprises at least one auxiliary arc, at least one portion of the plurality of light blocking structures is disposed on the at least one auxiliary arc, the at least one auxiliary arc has a curvature radius r, and the following condition is satisfied:
$$0.5 mm < r < 50 mm .$$

25. The light path folding module of claim 16, wherein a height of each of the plurality of light blocking structures extending along the direction perpendicular to the incident optical axis is Hi, and the following condition is satisfied:
$$0.01 mm < Hi < 1.2 mm .$$

26. The light path folding module of claim 16, wherein a length of each of the plurality of light blocking structures extending along a direction parallel to the incident optical axis is Li, and the following condition is satisfied:
$$0.1 mm < Li < 2.8 mm .$$

27. The light path folding module of claim 16, wherein the light path folding element is made of plastic material.

28. The light path folding module of claim 16, wherein the opaque body is made of black plastic material.
